(19) United States
(12) Patent Application Publication
(10) Pub. No.: US 2016/0125849 A1
(43) Pub. Date: May 5, 2016

(54) Electronic Image Separated Viewing and Screen Capture Prevention System and Method

(71) Applicant: Vaporstream, Inc., Chicago, IL (US)

(72) Inventors: Amit Jindas Shah, Chicago, IL (US); Aijaz Ansari, Glendale Heights, IL (US)

(73) Assignee: Vaporstream, Inc., Chicago, IL (US)

(21) Appl. No.: 14/532,249

(22) Filed: Nov. 4, 2014

(51) Int. Cl. G09G 5/38

(52) U.S. Cl. CPC G09G 5/38; G09G 2358/00

(57) ABSTRACT

An electronic image can be displayed such that a first portion of the electronic image and a second portion of the electronic image are displayed separately. An image display region may be displayed including a first portion of an electronic image displayed in a first subregion. Display of a second portion in a second subregion is done separately such that: when the first portion of the electronic image is displayed in the first subregion, a first substitute portion is displayed in the second subregion in place of the second portion; and when the second portion of the electronic image is displayed in the second subregion, a second substitute portion is displayed in the first subregion in place of the first portion. Systems, methods, and machine readable hardware storage media are provided for displaying an electronic image.

### RELATED APPLICATION DATA

This application is related to the following commonly-owned applications, each filed on the same day as the current application: U.S. patent application Ser. No. 14/532,287, titled “Divided Electronic Image Transmission System and Method;” U.S. patent application Ser. No. 14/532,319, titled “Networked Divided Electronic Image Messaging System and Method;” U.S. patent application Ser. No. 14/532,329, titled “Separated Viewing and Screen Capture Prevention for Electronic Video;” U.S. patent application Ser. No. 14/532,368, titled “Electronic Video Division and Transmission System and Method;” and U.S. patent application Ser. No. 14/532,381, titled “Networked Divided Electronic Video Messaging System and Method;” each of which is incorporated by reference herein in its entirety.

### FIELD OF INVENTION

The present invention generally relates to the field of electronic image messaging, modification, and display. In particular, the present invention is directed to an electronic image separated viewing and screen capture prevention system and method.

### BACKGROUND

As computing technologies and the Internet have grown, the ability to transfer larger amounts of data over a network has grown to be available to many people from a number of modes of communication. The myriad of applications, sometimes referred to simply as “apps,” available for mobile computing (e.g., smartphones, tablets, etc.) along with increasing bandwidth potential have created new avenues for creative electronic messaging, including messaging and network communication of images (e.g., an electronic photograph) and video in electronic form.

Sometimes a user would like to view, and/or send to someone else to view, an image. Several mechanisms exist for a user to transmit an image from one computing device to another computing device. Snapchat, Inc., for example, provides an app (SNAPCHAT) that allows a sending user to set a fixed amount of time that a recipient of an image or video has to view the image or video before the image or video is no longer viewable by the recipient. A recipient user can screencapture that image prior to the expiration of the time period for viewing. A screencapture creates a captured image of the display screen of the computing device and, thus, can preserve the received image or a still of the received video. ContentGuard, Inc. markets an app, YOVO, which allows display of an image with a filter over the image. The filter makes a screencaptured image appear less desirable. The filter seems to move across the display of the image while the image is displayed such that any screencapture will also include the filter.

### SUMMARY OF THE DISCLOSURE

In one example implementation, a method of viewing an electronic image on a user device is provided. The method includes displaying an image display region for the electronic image via a first computing device; displaying a first portion of the electronic image in a first subregion of the image display region; displaying a second portion of the electronic image in a second subregion of the image display region, the display of the first portion and the second portion being such that: when the first portion of the electronic image is displayed in the first subregion, a first substitute portion is displayed in the second subregion in place of the second portion; and when the second portion of the electronic image is displayed in the second subregion, a second substitute portion is displayed in the first subregion in place of the first portion; and automatically repeating the displaying of the first portion and the displaying of the second portion.

In another example implementation, a machine-readable hardware storage medium comprising machine executable instructions implementing a method of viewing an electronic image on a user device is provided. The instructions include a set of instructions for displaying an image display region for the electronic image via a first computing device; a set of instructions for displaying a first portion of the electronic image in a first subregion of the image display region; a set of instructions for displaying a second portion of the electronic image in a second subregion of the image display region, the display of the first portion and the second portion being such that: when the first portion of the electronic image is displayed in the first subregion, a first substitute portion is displayed in the second subregion in place of the second portion; and when the second portion of the electronic image is displayed in the second subregion, a second substitute portion is displayed in the first subregion in place of the first portion; and a set of instructions for automatically repeating the displaying of the first portion and the displaying of the second portion.

In yet another example implementation, a system for viewing an electronic image on a user device is provided. The system includes a means for displaying an image display region for the electronic image via a first computing device; a means for displaying a first portion of the electronic image in a first subregion of the image display region; a means for displaying a second portion of the electronic image in a second subregion of the image display region, the display of the first portion and the second portion being such that: when the first portion of the electronic image is displayed in the first subregion, a first substitute portion is displayed in the second subregion in place of the second portion; and when the second portion of the electronic image is displayed in the second subregion, a second substitute portion is displayed in the first subregion in place of the first portion; and a means for automatically repeating the displaying of the first portion and the displaying of the second portion.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A illustrates one exemplary implementation of an image;

FIG. 1B illustrates one exemplary implementation of a division of the image of FIG. 1A into a plurality of portions;

FIG. 1C illustrates one exemplary implementation of a display of one example portion of the image of FIG. 1A;

FIG. 1D illustrates one exemplary implementation of a display of another example portion of the image of FIG. 1A;

FIG. 2A illustrates another exemplary implementation of an image;

FIG. 2B illustrates one exemplary implementation of a division of the image of FIG. 2A into a plurality of portions;

FIG. 2C illustrates one exemplary implementation of another division of the image of FIG. 2A into a further plurality of portions;

FIG. 2D illustrates one exemplary implementation of a display of one example portion of the image of FIG. 2A;

FIG. 2E illustrates one exemplary implementation of a display of another example portion of the image of FIG. 2A;

FIG. 2F illustrates one exemplary implementation of a display of yet another example portion of the image of FIG. 2A;

FIG. 3A illustrates one exemplary implementation of a normalized coordinate scale for an example image;

FIG. 3B illustrates one set of exemplary coordinates of example portions of an image via the exemplary coordinate scale of FIG. 3A;

FIG. 4 illustrates one exemplary implementation of one embodiment of a method of displaying a plurality of portions for an image;

FIG. 5 illustrates one example of a portable handheld computing device;

FIG. 6 illustrates another example of a portable handheld computing device;

FIG. 7 illustrates one example diagrammatic representation of one implementation of a computing device;

FIG. 8A illustrates one exemplary implementation of a display of a first example portion of an image in an exemplary separate successive display of a plurality of portions;

FIG. 8B illustrates one exemplary implementation of a display of a second example portion of an image in an exemplary separate successive display of a plurality of portions;

FIG. 9A illustrates one example of a substitute portion used in an exemplary separated display of portions of an image;

FIG. 9B illustrates another example of a substitute portion used in an exemplary separated display of portions of an image;

FIG. 10A illustrates yet another example of a substitute portion used in an exemplary separated display of portions of an image;

FIG. 10B illustrates still another example of a substitute portion used in an exemplary separated display of portions of an image;

FIG. 11A illustrates one exemplary implementation of a display of a first example portion of an image in an exemplary separate successive display of a plurality of portions;

FIG. 11B illustrates one exemplary implementation of a display of a second example portion of an image in an exemplary separate successive display of a plurality of portions;

FIG. 11C illustrates one exemplary implementation of a display of a third example portion of an image in an exemplary separate successive display of a plurality of portions;

FIG. 12 illustrates one exemplary implementation of method of dividing an image into a plurality of portions;

FIG. 13 illustrates another exemplary implementation of method of dividing an image into a plurality of portions;

FIG. 14 illustrates yet another exemplary implementation of method of dividing an image into a plurality of portions;

FIG. 15A illustrates one exemplary implementation of an interface for dividing an image;

FIG. 15B illustrates the exemplary interface for dividing an image of FIG. 15A with an example of a line positioned to divide an image;

FIG. 15C illustrates the exemplary interface for dividing an image of FIG. 15A with another example of a line positioned to divide an image;

FIG. 16 illustrates one example of a networking environment;

FIG. 17 illustrates another example of a networking environment;

FIG. 18 illustrates one exemplary implementation of a method of transmitting an image;

FIG. 19 illustrates one exemplary implementation of a method of displaying a divided image;

FIG. 20 illustrates another exemplary implementation of a method of displaying a divided image;

FIG. 21 illustrates yet another exemplary implementation of a method of displaying a divided image;

FIG. 22 illustrates one exemplary implementation of an interface for designating one or more recipients for an image;

FIG. 23 illustrates another exemplary implementation of an interface for dividing an image;

FIG. 24A illustrates one exemplary implementation of an example an image;

FIG. 24B illustrates one exemplary implementation of an automatic division of the image of FIG. 24A into a plurality of portions using facial recognition; and

FIG. 24C illustrates one exemplary implementation of a display of separated portions of FIG. 24B.

### DETAILED DESCRIPTION

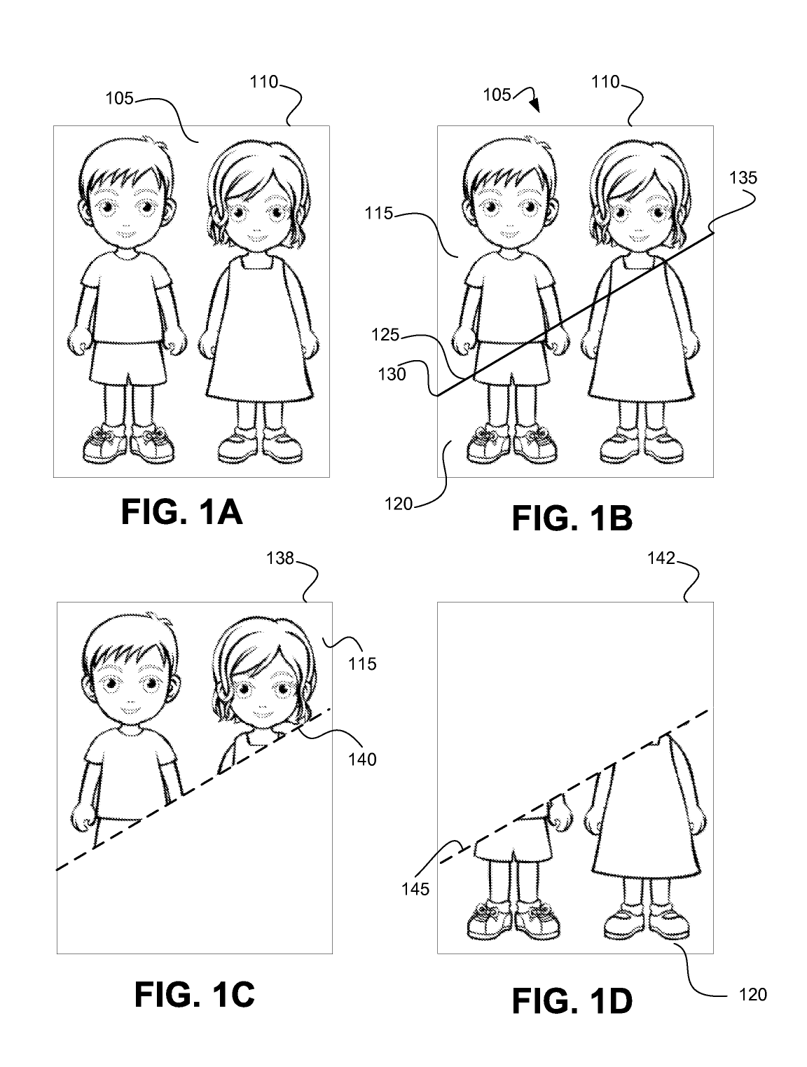

FIG. 1A shows a representation of an exemplary electronic image 105 and one example of image 105 divided into a plurality of portions. Image 105 has a perimeter 110 that encloses an area within the perimeter. Image 105 is shown as a rectangular image in a portrait orientation (i.e., with a height greater than a width) and a rectangular perimeter 110. In alternative implementations, an electronic image can have any of a variety of different shapes and configurations (orientation, aspect ratio, resolution, etc.). For example, a rectangular image in one or more other examples may have a landscape orientation (i.e., with a width greater than a height). Example shapes for an electronic image include, but are not limited to, a square, a rectangle, a circle, a polygon, an ellipse, a triangle, a diamond, a shape with no corners, a shape with no edges, a shape with no vertices, and any combinations thereof. Perimeter 110 is shown as a visible outlined rectangle for purposes of assisting the visualization of the edges of image 105 and the location of the perimeter 110 of image 105. A perimeter of an electronic image displayed via a computing device may or may not have such a visible outline when displayed. For example, a display of an electronic image on a display element of a computing device may include the emission of light from the display element based on the data representing the image in such a way that the emission of light representing the image terminates at the edges of the image on the display element (e.g., pixels adjacent to the pixels of the edges of the image may be non-active regions of the display element and/or other active regions of the display element representing the display of items other than the image without a visible demarcation, such as the lined perimeter shown in the figures of the current disclosure for visualization purposes). Example computing devices and display elements are discussed further below. An image depicted in the figures of this disclosure with a border demarcation also exemplifies an image display without such a border demarcation. An image may depict any subject matter that is capable of being recorded in an image. Additionally, a displayed image may only display a part of the original image due to down-sampling, cropping, and/or stretching.

An electronic image can be any type of image in an electronic form. Various data formats for electronic images are known and may be developed in the future, any of which may be utilized in one or more implementations and embodiments disclosed herein. Example data formats for an electronic image include, but are not limited to, joint photographic experts group (JPEG), JPEG file interchange format (JIFF), exchange image file format (Exif), tagged image file format (TIFF), a RAW format (e.g., ISO 12234-2, TIFF/EP, proprietary RAW formats of various camera manufacturers), graphics interchange format (GIF), Windows bitmap format (BMP), portable network graphics format (PNG), portable pixmap file format (PPM), portable graymap file format (PGM), portable bitmap file format (PBM), WebP format, an HDR raster format, JPEG XR format, SGI format, personal computer exchange (PCX) format, computer graphics metafile (CGM), scalable vector graphics (SVG), a raster file format, a vector file format, and any combinations thereof.

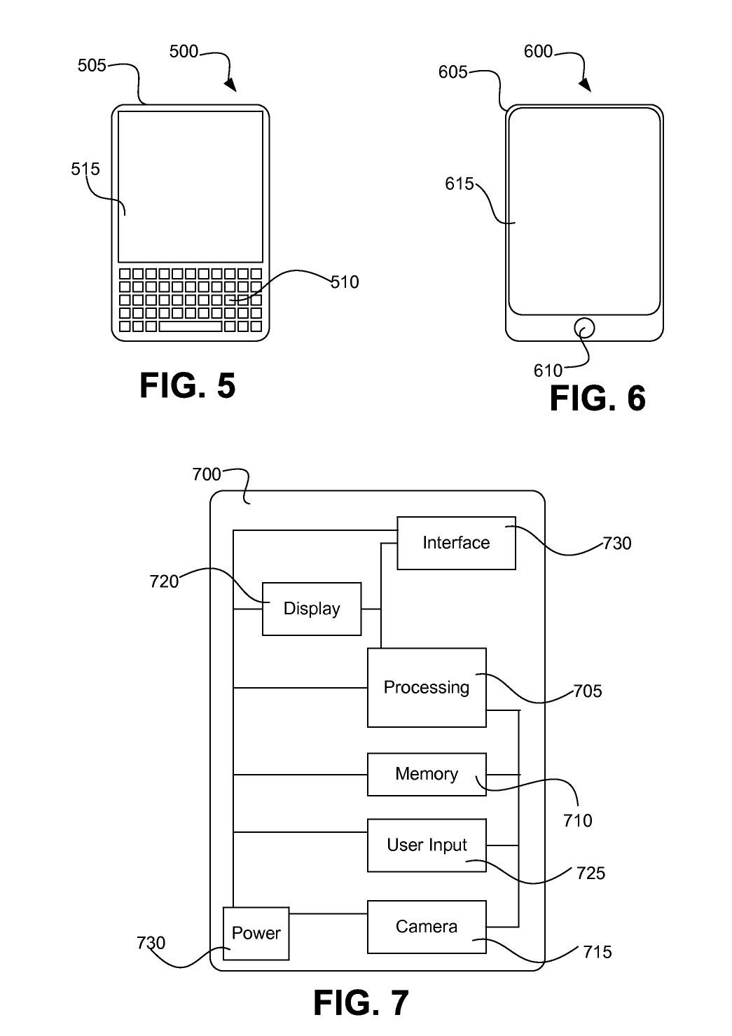

Electronic images, such as image 105, can be utilized using one or more computing devices. For example, an electronic image can be acquired by, modified with, divided by, displayed by, transmitted from, and/or received by a computing device. A computing device is any machine that is capable of executing machine-executable instructions to perform one or more tasks. Examples of a computing device include, but are not limited to, a smartphone, a tablet, an electronic book reading device, a workstation computer, a terminal computer, a server computer, a personal digital assistant (PDA), a mobile telephone, a portable and/or handheld computing device, a wearable computing device (e.g., a watch), a web appliance, a network router, a network switch, a network bridge, one or more application specific integrated circuits, an application specific programmable logic device, an application specific field programmable gate array, any machine capable of executing a sequence of instructions that specify an action to be taken by that machine (e.g., an optical, chemical, biological, quantum and/or nanoengineered system and/or mechanism), and any combinations thereof. In one example, a computing device is a smartphone. A computing device may utilize any of a variety of known or yet to be developed operating systems. Examples of an operating system include, but are not limited to, Apple's iOS, Blackberry operating system, Amazon's Fire OS, Google's Android operating system, Microsoft's Windows Phone operating system, Samsung's Bada operating system, Microsoft's Windows operating system, Apple's Operating System X, a Linux-kernel based operating system, and any combinations thereof. Example implementations of a smartphone are discussed further below with respect to FIGS. 5 and 6. An additional example of a computing device and computing environment are discussed further below with respect to FIG. 7. A computing device may include and/or be programmed with specific machine-executable instructions and include required circuitry and components such that the combination of the circuitry/components and the instructions allow it to perform as a specialized machine in one or more of the implementations disclosed in the current disclosure.

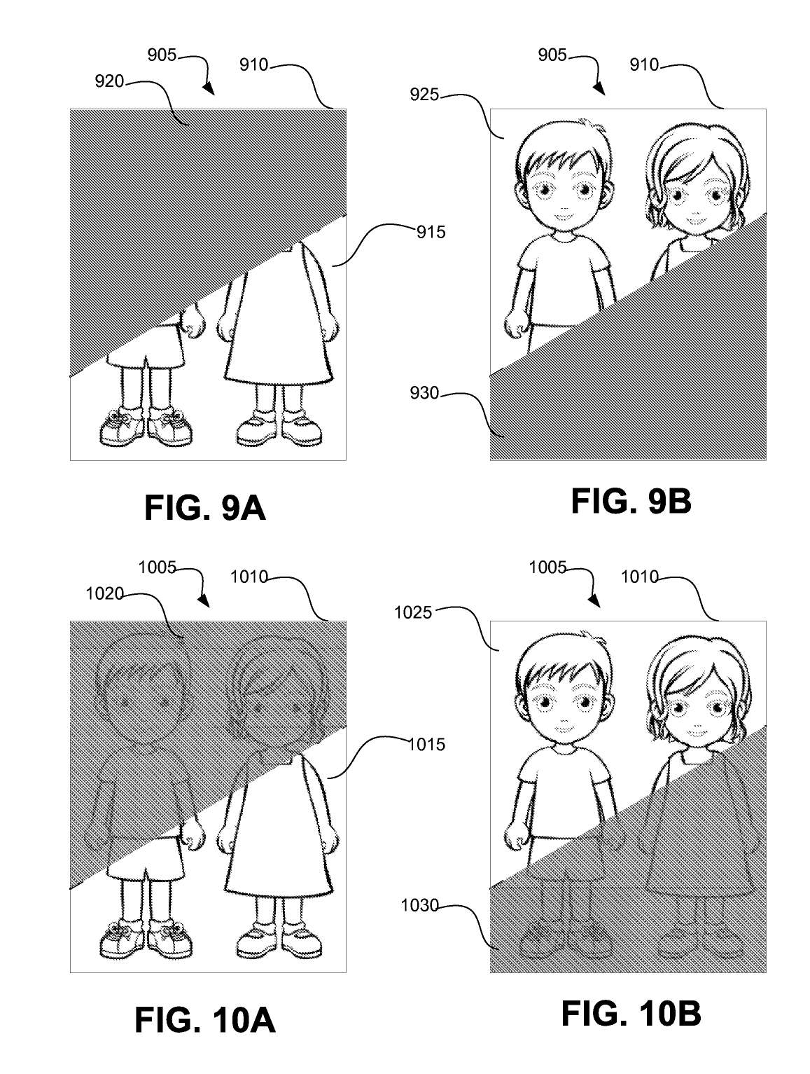

FIG. 1B shows image 105 divided into two portions (portion 115 and portion 120) by line 125. Image 105 is shown divided by a line. In alternative implementations an electronic image can be divided using other mechanisms, examples of which are discussed further below. Similar to the depictions of a border outline, a line shown in the figures of this disclosure between portions of an image may or may not be visible in a display of one or more of the portions of an image. A line, such as line 125, used for dividing an electronic image may include any type of line. Example lines include, but are not limited to, a curved line, a straight line, a wave-shaped line, a jagged line, and any combinations thereof. Image 105 is shown divided into two portions. Image 105 can be divided into any number of two or more portions. In one such example, a second line (not shown) can be used to divide one of the portions 115/120 formed by line 125 into two portions resulting in three total portions. In another such example, a second line (not shown) can be used to divide both of the portions 115/120 formed by line 125 into two portions resulting in four total portions. An example using two lines to form three portions is discussed further below with respect to FIGS. 9A to 9F. It is contemplated that an electronic image can be divided into any number of portions (e.g., using any number of lines or other techniques for dividing an image).

In the implementation shown in FIG. 1B, line 125 connects one edge of perimeter 110 (at location 130) to another edge of perimeter 110 (at location 135). In this example, line 125 is shown ending at perimeter 110. In alternative examples, one or both ends of a line dividing an electronic image may extend beyond the perimeter of an electronic image. One or more additional lines may be used to divide an image into three or more portions. In one such example, an additional line connects one edge of a perimeter of an image to another line dividing the image. In another such example, an additional line connects one edge of a perimeter of an image to another edge of a perimeter of the image (e.g., non-intersecting another line, intersecting another line). A line dividing an image may have an appearance with a visible line width when the line is displayed, such as when displayed as part of an interface for dividing one or more images or a display screen for displaying one or more portions separately (examples of which are discussed in more detail below). Segments of the image that share the same area as the line (e.g., displayed pixels of the image that are covered by the display of the line) may be handled in a variety of ways with respect to which portion to assign the segments. Examples of ways to handle the assignment of segments of an image occupying the same area as a line include, but are not limited to, assigning some of the shared segment of an image to one portion and some of the shared segment of the image to the another portion, treating the line as having no width (e.g., by defining each portion based on points of intersection of the line with a perimeter of the image and/or with another line), assigning all of the shared segment of an image to one portion, and any combinations thereof.

Division of an electronic image, such as image 105, into two or more portions can be achieved in a variety of ways. Examples of ways to divide an electronic image include, but are not limited to, providing a user of a computing device with an interface for receiving instructions from the user for dividing the electronic image into two or more portions, automatically dividing the electronic image into two or more portions, positioning a line at a location of an image, dividing an image into a plurality of polygons, and any combinations thereof. In one example, a user interface is provided to a user of a computing device, the interface being configured to allow the user to input instructions for dividing one or more images each into a plurality of portions. In another example, a user interface is provided to a user of a computing device, the interface being configured to allow the user to position one or more lines to divide an image into a plurality of portions. In yet another example, a user interface is provided to a user of a computing device, the interface being configured to allow the user to define a plurality of polygons dividing one or more images each into a plurality of portions. In still another example, a computing device automatically divides one or more images each into a plurality of portions. Automatic division of an electronic image may be performed by a computing device specially programmed for the dividing of an electronic image by any of a variety of ways consistent with the current disclosure. Examples of ways to automatically divide an electronic image include, but are not limited to, using facial recognition to identify a region of an image containing at least part of a face of a subject in the image and dividing the image to place the at least part of a face in a first portion, randomly dividing the image into two or more portions, using a predefined location for dividing the image into two or more portions, using predefined information to divide the image into two or more portions, and any combinations thereof.

In one example, line 125 (and any additional lines) is positioned on image 105 by a user of a computing device via an interface provided to the user and instructions received via the computing device from the user. In another example, line 125 (and any additional lines) is positioned on image 105 automatically by a computing device (e.g., using a random placement, using facial recognition to identify a location of one or more faces, using other predefined criteria for placement, etc.). In another example, at least one line (such as line 125) is positioned on an image (such as image 105) automatically by a computing device and another line is positioned on the image using an interface provided to a user and receipt of instructions from the user.

A divided image may be in a variety of forms that allow the display of the portions of each image to be displayed separately. Example forms of a divided image include, but are not limited to, separate image files for each set of corresponding portions of an image (i.e., a first portion in one image file, a second portion in another image file, etc.), an image file associated with segment information defining the division of an image into portions, and any combinations thereof. Segment information can be used to display a divided image via a computing device with each portion an image being displayed separately in a successive display screen. Examples of segment information include, but are not limited to, user defined information, one or more coordinates defining a location and/or shape of a portion of an image, information regarding a shape of a portion within an image, information regarding a location of a portion within an image, information identifying vertices of a polygon-shaped portion, file correlation information for combining separate image files, and any combinations thereof. Examples of coordinate information includes, but is not limited to, coordinate information based on a normalized coordinate system of an image, coordinate information based on an absolute measurement of dimensions of an image, one or more coordinates of one or more lines, one or more coordinates of a set of vertices for a polygon shaped portion, one or more coordinates expressed in points, one or more coordinates expressed in percentages, one or more coordinates expressed in pixels, one or more coordinates expressed in another unit (e.g., inches, centimeters, millimeters, pica, etc.), another coordinate system, and any combinations thereof. Segment information may be associated with an image file in a variety of ways including, but not limited to, as a separate file from an image file, as file metadata, and/or as data embedded in an image file.

A divided image may provide one or more benefits in displaying the divided image with portions displayed in separate screen displays. Examples of a benefit include, but are not limited to, prevention of screen capture of an entire image, protection of identity of a subject within an image, an entertainment benefit, prevention of recording of an image with another video and/or still image capture device, and any combinations thereof.

Each of the plurality of portions of a divided image can be displayed via a computing device. In one example, a divided image is displayed at a computing device used to divide the image. In another example, a divided image is displayed at a different computing device from the computing device used to divide the image. An image, a divided image, and/or one or more portions of an image (along with other information) may be transmitted from one computing device (e.g., a “sending computing device”) to another computing device (e.g., a “recipient computing device”). An intermediate computing device (e.g., a server computing device) may also be employed in a transmission.

FIG. 1C shows portion 115 of image 105 displayed in a first subregion of the area within a screen display 138 having a rectangular area that is similar in shape and proportional in size to the corresponding image (here, image 105, from which the displayed portion was divided. Other configurations for an area of a screen display may also be representative of an area of an image. For example, a screen display may have a different shape and or size configuration than that of the original image. Screen displays are shown in the figures with a visible rectangular border demarcation for assistance in visualizing the screen display area. A dashed line 140 is utilized in the depiction to assist with visualizing the boundary of portion 115 and the subregion occupied by the portion and the location where line 125 divided the image. A border demarcation and/or a dashed line may or may not be visible in a display of a portion of an image. In one such example, a portion of an image may be displayed without a border demarcation as to the edge of the image or portion of an image (e.g., other than the edges of the portion itself, the display of a computing device, and/or the display region of a display element of a computing device). The first subregion is shown in this example bounded by dashed line 140 and the segments of the border of screen display 138. FIG. 1D shows portion 120 of image 105 positioned in a second subregion of the area within a screen display 142, the second subregion shown in this example bounded by a dashed line 145 and the segments of a border of screen display 142 adjacent to portion 120. Dashed line 145 is shown in FIG. 1D to assist with visualization of the subregion occupied by the portion and the location where line 125 divided the image. Dashed line 140, 145 (or another representation of a division) and/or a visual representation of perimeter 110 may or may not be visible in actual implementations of display of an electronic image or a portion of an electronic image according to the current disclosure.

Prior to display of a portion of an electronic image to a user, the portion may be changed by having an image parameter of the portion of the image modified. Examples of an image parameter include, but are not limited to, a picture quality parameter, an image exposure parameter, an image lighting parameter, an image aperture parameter, an image zoom parameter, an image size parameter, an image color, an image contrast, an image luminance and any combinations thereof. An image parameter can be modified in a variety of ways. Ways of modifying an image parameter include, but are not limited to, providing a user of a computing device with an interface for providing an instruction for modifying an image parameter, automatically modifying an image parameter, modifying an image parameter based on a predetermined modification, and any combinations thereof. An image parameter of a portion of an image may be modified at any time prior to a display of the portion in which it is desired to have the image parameter changed. Example times for modifying an image parameter of a portion of an image include, but are not limited to, at a time prior to an image portion being transferred from a sending computing device to a receiving computing device (e.g., via providing a sending user with an interface for making the modification prior to transmission from the sending computing device), at a time after the image portion is transferred from a sending computing device and before the image portion is transferred to a target viewing computing device (e.g., automatic modification at an intermediate computing device, such as a server computer, prior to transmission to an intended recipient), at a time after the image portion is received at a target viewing computing device (e.g., automatic modification performed by machine executable instructions and processing circuitry on the target viewing computing device prior to display of the image portion), and any combinations thereof. A predetermined image modification is a particular modification that is known and desired (e.g., by one or more designers of a system that allows one or more of the functionalities of displaying a divided electronic image, dividing an electronic image, and/or other implementation according to the current disclosure).

A screen display (such as screen displays 162, 166, 170, 174, 178, 182) may be displayed via an image display region of a display element. An image display region may have an area that corresponds to an area of an image for which a portion is to be displayed. An image display region is a region of a display element associated with a computing device configured for the display of one or more portions of an image. Examples of a display element include, but are not limited to, a computer monitor, a liquid crystal display (LCD) display screen, a light emitting diode (LED) display screen, a touch display, a cathode ray tube (CRT), a plasma display, and any combinations thereof. A display element may include, be connected with, and/or associated with adjunct elements to assist with the display of still and/or moving images. Examples of an adjunct display element include, but are not limited to, a display generator (e.g., image/image display circuitry), a display adapter, a display driver, machine-executable instructions stored in a memory for execution by a processing element for displaying still and/or moving images on a screen, and any combinations thereof.

Two devices, components, elements, and or other items may be associated with each other in a variety of ways. Example ways to associate two items include, but are not limited to, one item being an internal component to another item, one item being an external portion to another item (e.g., an external LED touch screen of a smartphone computing device), one item being connected externally to another item via a wired connection (e.g., a separate LED display device connected via a wire to a computing device, an external memory device connected via a Universal Serial Bus (USB) connection to a computing device, two items connected via Ethernet), one item being connected externally to another item via a wireless connection (e.g., two devices connected via a Bluetooth wireless, cellular, WiFi connection and/or other wireless connection), one item connected to another item via an external port or other connector of the other item (e.g., a USB flash drive, such as a “thumb drive” plugged into an external USB port of a computing device), one item removeably connected to another item, and any combinations thereof.

An image display region may occupy any amount of the displayable portion of a display element. A displayable portion of a display element is the portion of the display element capable of producing a visible display to a user. In one example, an image display region occupies substantially the entire displayable portion of a display element. In another example, an image display region occupies part of the displayable portion of a display element.

An image display region can have a variety of shapes and configurations. Examples of a shape for an image display region include, but are not limited to, a square, a rectangle, a circle, a polygon, an ellipse, a triangle, a diamond, and any combinations thereof. In one example, an image display region has the shape of an electronic image for which the image display region is configured to display. In another example, an image display region has a shape different from an electronic image for which the image display region is configured to display.

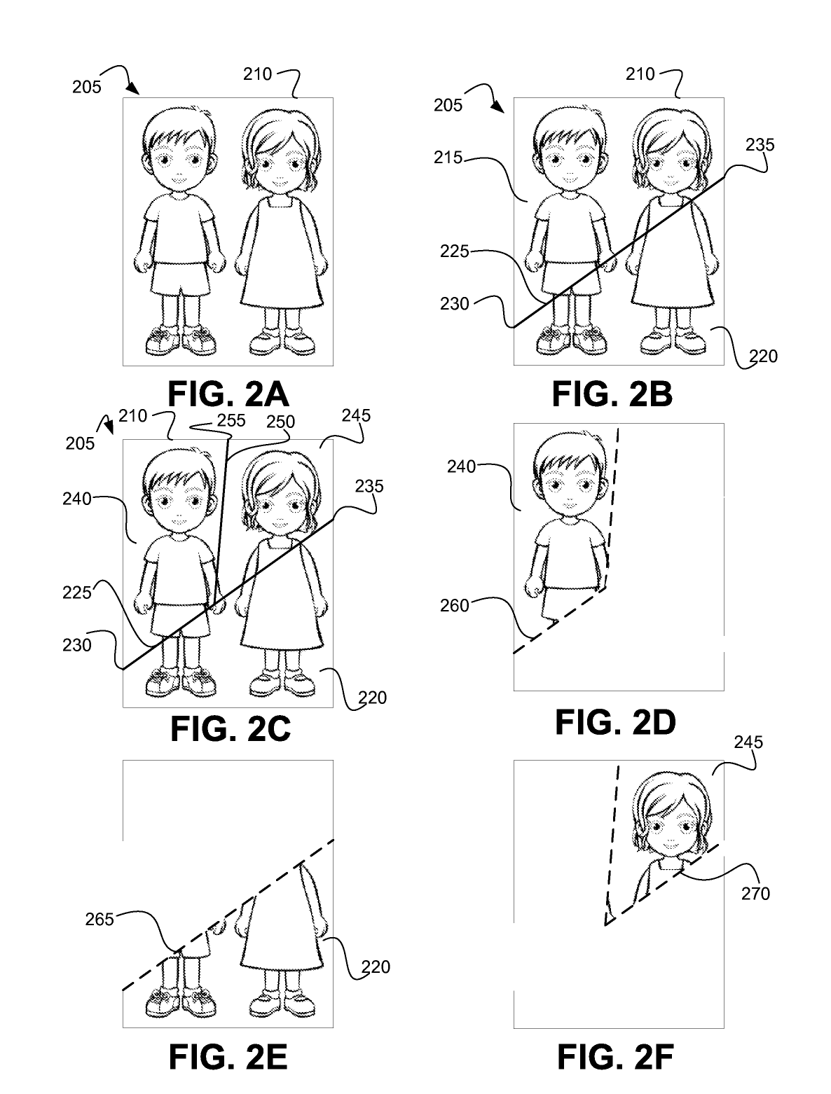

FIGS. 2A to 2F illustrate one exemplary implementation of a divided electronic image 205 having an area bounded by a perimeter 210. For discussion purposes, FIGS. 2A to 2F show division of an image into three portions. It should be understood that image 205 may be divided into any number of portions. For the sake of brevity, some of the details, concepts, aspects, features, characteristics, examples, and/or alternatives discussed above with respect to FIGS. 1A to 1D (and in other locations in this disclosure) are not repeated in the discussion of image 205 and FIGS. 2A to 2F. Any one or more of the details, concepts, aspects, features, characteristics, examples, and alternatives may be included to the implementation described in FIGS. 2A to 2D as applicable, except where noted.

Here, perimeter 210 is shown by a line. As discussed above, an electronic image and/or a portion thereof may not have a visible line as a perimeter (e.g., the image and/or portion terminating at the edge of the area defining the image without a visible demarcation on a display element). In this example, image 205 has a rectangular shape. As discussed above, an electronic image and an image display region may have a shape different than a rectangular shape. FIG. 2B shows image 205 divided into a portion 215 and a portion 220 by a line 225. Line 225 connects to an edge of perimeter 210 at location 230 and to an edge of perimeter 210 at location 235. Here, line 225 is shown to terminate at perimeter 210. A line, such as line 225 may alternatively extend (e.g., on a display of a display element) beyond the outside of the area of the electronic image at location 230 and/or 235.

FIG. 2C shows portion 215 being further divided into a portion 240 and 245 by a line 250 that extends from location 255 at perimeter 210 to connect to line 225. The lines at the divisions of the image in the examples shown in FIGS. 2B and 2C are each shown in contact with edges of the image without crossing the other line. In another example, a first line divides an image by connecting two edges of the image (i.e., at the perimeter) and a second line further divides the image by connecting an edge of the image and the first line. In one such example, one or more additional lines may also further divide the image (e.g., by connecting edges of the image, by connecting an edge of the image to the first line, by connecting an edge of the image to the second line, by connecting the first line to the second line, etc.). In yet another example, a first line divides an image by connecting two edges of the image and a second line further divides the image by connecting an edge of the image and the first line. In such an example, one or more additional lines may also further divide the image (e.g., by connecting edges of the image, by connecting an edge of the image to the first line, by connecting an edge of the image to the second line, by connecting the first line to the second line, etc.). In still another example, a first line divides an image by connecting two edges of the image and a second line further divides the image by connecting edges of the image and crossing the first line. In such an example, one or more additional lines may also further divide the image (e.g., by connecting edges of the image, by connecting an edge of the image to the first line, by connecting an edge of the image to the second line, by connecting the first line to the second line, etc.). Portions 220, 240, and 245 are each shaped as polygons with four sides and vertices at each corner. As discussed above, portions of an image may be defined by their polygon shape and the location of the polygon shape.

FIG. 2D shows portion 240 displayed separately from portions 245 and 220. FIG. 2E shows portion 220 displayed separately from portions 240 and 245. FIG. 2F shows portion 245 displayed separately from portions 220 and 240. A dashed line 260, a dashed line 265, and a dashed line 2701 are shown to assist visualization of a position of portions 240, 220, and 245, respectively that occupies a subregion of the area of the original electronic image 205 that corresponds to the location that portions 240, 220, and 245, respectively occupied originally. Dashed lines 260, 265, 270 may be omitted in any display of portions 240, 220, and/or 245 according to any implementation disclosed herein. Additionally, the rectangular outlines shown in FIGS. 2D, 2E, and 2F are for assistance in visualizing the related positions of portions 240, 229, 245 in subregions of the area of the original electronic image 205 and such outlines may be omitted in any implementation of a display of a portion of an image. It is also contemplated that portions of an electronic image may be alternatively displayed separately on a display of a display element (e.g., via an image display region) with one or more of the portions located in a subregion of the image display region that does not correspond to the original location of the portion in the electronic image relative to the other portions.

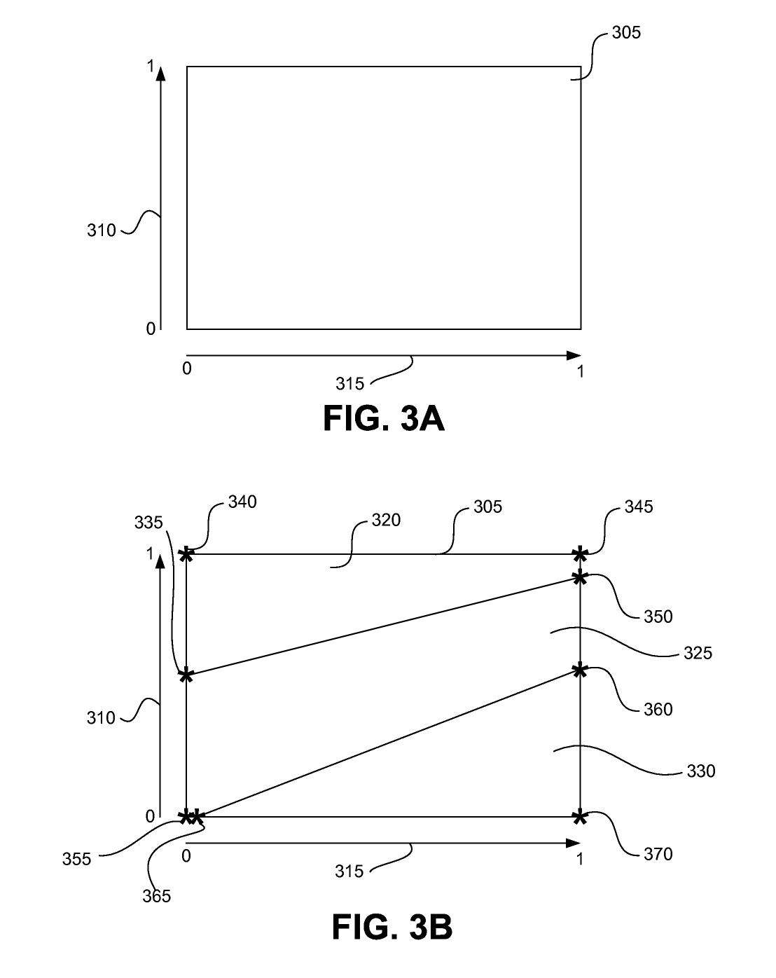

As discussed above a divided image may be associated with information that defines the location and/or shape of a portion of the image within the image. In one example, such information includes coordinate information. In one such example, coordinate information may be based on normalizing the dimensions of an image such that the dimensions are measured from a value of zero to a value of one. In one exemplary aspect, a similar and/or proportionate system may also be used for a corresponding screen display and/or a corresponding image display region. FIGS. 3A and 3B illustrate one exemplary implementation of a normalized coordinate scale system for an image 305. FIG. 3A shows image 305 with a vertical normalized scale 310 having values from 0 to 1 and a horizontal scale 315 having values from 0 to 1.

In one example, such a coordinate system is used to define an exemplary division of image 305 in three portions 320, 325, 330 shown in FIG. 3B. Portion 320 is defined by coordinates of {0.0000,0.5350}, {0.0000,1.0000}, {1.0000,1.0000},{1.0000,0.9181}. Coordinates are given in {horizontal axis, vertical axis} form where each set of { } coordinates represents a vertex of the polygon portion. In other examples different coordinate formats may be utilized. Portion 325 has coordinates of {0.0000,0.5350}, {0.0000,0.0000}, {0.0286,0.0000}, {1.0000,0.5623}, {1.0000,0.9181}. Portion 330 has coordinates of {0.0286,0.0000}, {1.0000,0.0000}, {1.0000,0.5623}.

In FIG. 3B portion 320 has vertices at a location 335 (corresponding to {0.0000,0.5350}), a location 340 (corresponding to {0.0000,1.0000}), a location 345 (corresponding to {1.0000,1.0000}), and a location 350 (corresponding to {1.0000,0.9181}). Portion 325 has vertices at a location 355 (corresponding to {0.0000,0.0000}), location 335, location 350, a location 360 (corresponding to {1.0000,0.5623}), and a location 365 (corresponding to {0.0286,0.0000}). Portion 330 has vertices at location 365, location 360, and a location 370 (corresponding to {1.0000,0.0000}). Locations 335, 340, 345, 350, 355, 360, 365, 370 are shown in FIG. 3B with asterisks to assist with visualization. It should be understood that such asterisks may not be displayed in a display of image 105.

One potential benefit of using a normalized scale coordinate system may be the ability to divide an image of an image similarly in a situation where the image has one set of unit dimensions, and a screen display and/or image display region has a different set of unit dimensions.

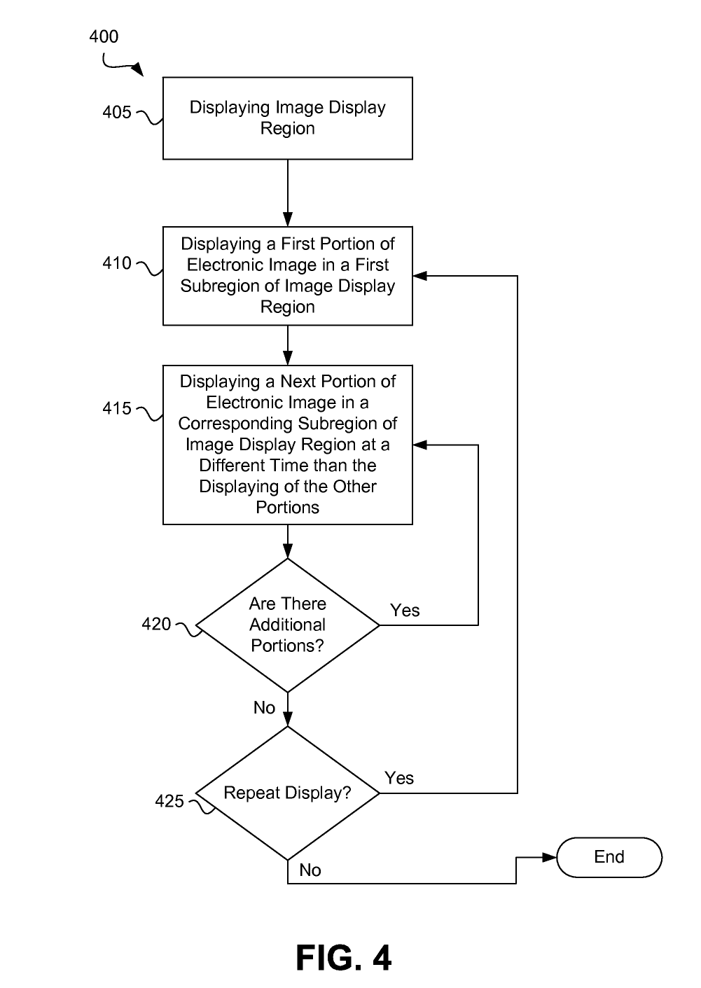

FIG. 4 illustrates one exemplary implementation of a method 400 of displaying an electronic image according to the present disclosure. At step 405, an image display region is displayed using a computing device.

At step 410, a first portion of an electronic image that has been divided into two or more portions is displayed in a subregion of the image display region, the subregion corresponding to a location for the first portion in the electronic image. Step 405 and step 410 are listed as separate steps. It is contemplated that these separate steps 405 and 410 can occur in implementation relatively simultaneously. In one such example, a computing device displays an image display region at about the same time as the display of a first portion of an electronic image. In another such example, a computing device displays an image display region at the same time as the display of a first portion of an electronic image. It is not necessary that the image display region be perceivable by a user of a computing device prior to perception/visibility of a first portion to satisfy the separate listing of step 405 and step 410.

When a portion of an image is displayed in a subregion of a screen display, the display of the other subregions of the screen display (e.g., those corresponding to the other portions of the image) may be handled in a variety of ways. Example ways for handling the other subregions of a screen display that do not include a display of the selected portion include, but are not limited to, displaying a default set of pixels for the display element in one or more of the other subregions, not displaying any portion of the image that is not the selected one portion for the particular screen display, displaying a substitute portion in one or more of the other subregions, displaying another portion, and any combinations thereof. In one example, when each portion of an image is displayed in a corresponding subregion of a separate successive screen display, no other portions of the image are displayed in the other subregions of the screen display. In another example, when each portion of an image is displayed in a corresponding subregion of a separate successive screen display, one or more substitute portions are displayed in the other subregions of the screen display.

Examples of a substitute portion include, but are not limited to, a greyscale portion, a black portion, a white portion, a colored portion, a blurred version of the original portion, a version of the original portion having a filter applied, a version of the original portion having one or more image parameters modified, a user-defined substitute displayable element (e.g., defined and/or selected via an interface provided to a user), and any combinations thereof. Examples of an image parameter are discussed above In one example, a substitute portion is a displayable portion in which data is provided to a display element of a computing device to display that data in place of an original portion. Additional examples of substitute portions are discussed further below with respect to FIGS. 9A, 9B, 10A, 10B and other locations.

A substitute portion may be in the form of machine-displayable information stored in a memory of a computing device. In one example, one or more substitute portions are stored on a computing device used to display the one or more substitute portions. A substitute portion may be provided to a computing device used for display of the substitute portion by another computing device. A substitute portion may be created by a computing device (e.g., a sending computing device, an intermediate computing device, a recipient computing device used to display the substitute portion). In one example, a substitute portion is created using machine-executable instructions and modification of a portion of an image of a subregion of an image corresponding to a subregion of display for the substitute portion. A substitute portion may be created automatically (e.g., using machine executable instructions and a processing element).

In one exemplary alternate implementation, if there are three or more portions of an image, more than one portion may be displayed at the same time in a separate successive screen display. In one example, when a first portion of an image is displayed in a first subregion of a screen display at least one other subregion of the screen display does not have a display of a corresponding other portion of the image. In one such example, one other subregion of the screen display does not have a display of a corresponding other portion of the image and successive screen displays have alternate subregions without a portion of the image displayed. In another such example, two or more portions are displayed in corresponding subregions, more than one other subregion of the screen display does not have a display of a corresponding other portion of the image, and successive screen displays have alternating subregions without a portion displayed. Other examples of variations are possible and should be understood from the disclosure herein. Such examples in which at least one of the portions is not displayed at the same time as one or more other portions can represent the separated display of portions (e.g., where each image of a plurality of images is displayed in at least two separate screen displays, each with at least one portion of an image not displayed).

At step 415, a next portion of the electronic image is displayed in another subregion of the image display region, the subregion corresponding to a location for the next portion in the electronic image. The first portion and the next portion are not displayed at the same time. In one example, when the first portion is displayed in the corresponding subregion, a substitute portion is displayed in the subregion corresponding to the next portion, and when the next portion is displayed in the subregion corresponding to the next portion, a substitute portion is displayed in the subregion corresponding to the first portion. In one example, when a portion is displayed in a subregion of an image display region, the remaining portions of the image are not displayed at the same time and one or more substitute portions are displayed in place of the remaining portions.

At step 420, if additional portions exist (e.g., the electronic image has been divided into three or more portions), the method proceeds to repeat step 415 for the next image portion. If no additional portions exist, the method proceeds to step 425.

At step 425, it is determined if the separate display of the plurality of portions of the electronic image is to repeat. If so, the method proceeds to step 410. If the display is to not repeat, the method proceeds to an end at step 430.

In one exemplary aspect, the alternating separate display of the plurality of portions may appear to a viewer of the display as if the entire image is displayed to the user. The rate of alternation may have an impact on the perception of the user of the image. For example, a very fast alternating of the display of portions may appear to a user as if no alternating is being performed. The rate of alternating the display of portions of an electronic image according to the disclosure herein may occur at any rate desirable for a given effect (e.g., clear perception of separated display, perception of near simultaneous display, perception by a user that the display is simultaneous, etc.).

A display element may have one or more settings for a frame rate capability of the display element at which the display element can produce consecutive display of unique images. Examples of a frame rate of a display element include, but are not limited to, 24 frames per second, 23.976 frames per second (e.g., an NTSC standard frame rate), 25 frames per second (e.g., a PAL standard frame rate), 30 frames per second, 48 frames per second, 50 frames per second, 60 frames per second, 72 frames per second, 90 frames per second, 100 frames per second, 120 frames per second, and 300 frames per second. In one example, the consecutive display of screen displays having portions of an image by a display element are unique displays from one to the next. In another example, at least some of the consecutive display screens displayed by a display element are not unique from one to the next.

For a display of each of a plurality of portions of an image in separate successive screen displays (e.g., that shown in FIGS. 1C and 1D) the images displayed consecutively by a display element can be the screen displays (e.g., screen displays 138, 142). A display screen rate is the frequency of displaying a series of display screens of a process of displaying each of a plurality of portions of an image in separate successive screen displays. An effective frame display rate is the frequency of display of all the portion screen displays for a given image. An effective frame display rate is the display screen rate divided by the number of screen displays corresponding to each image. For example, in FIGS. 1C and 1D the image has two corresponding screen displays (each displaying one of two portions of the image). In this example, if the display screen rate was 60 screen displays per second (e.g., matching one of the capabilities of the display element display rate) the effective frame display rate is 30 frames per second (60 screen displays per second/2).

A display screen rate for a divided image may be the same as any of the frame rates supported by a display element. In one example, an image divided into three portions can be displayed using a display screen rate of 60 display screens per second via a display element having a display frame rate capability of 60 frames per second such that the effective frame display rate is 20 frames per second (60 screen displays per second/3). A user viewing such a display may perceive the image as if an undivided image was being displayed via a display element at a 20 frame per second rate. In another example, an image divided into two portions can be displayed using a display screen rate of 60 display screens per second via a display element having a display frame rate capability of 60 frames per second such that the effective frame display rate is 30 frames per second (60 screen displays per second/2). A display element display rate and/or a display screen rate may vary during the alternating display of portions of an image.

As discussed above, one example of a computing device that may be utilized in one or more of the implementations of a method of the present disclosure is a handheld computing device. FIG. 5 illustrates one example of a portable handheld computing device in the form of a smartphone 500. Smartphone 500 includes a body 505, a keyboard user input element 510, and a display element 515. Display element 515 may be a touch screen to provide a user with additional input interface capabilities. A computing device, such as smartphone 500, may be used in a variety of ways with respect to any of the methods described herein. Exemplary ways to utilize smartphone 500 (or another computing device) include, but are not limited to, acquiring an image; storing an image, one or more portions of an image, and/or a divided image; dividing an image; transmitting an image, one or more portions of an image, and/or a divided image to another computing device; receiving an image, one or more portions of an image, and/or a divided image from another computing device; displaying each portion of a plurality of portions of an image separately, displaying each portion of a plurality of portions of an image in separate successive screen displays; modifying an image parameter of one or more portions of an image; providing an interface to a user of a computing device; receiving an instruction (and/or other input) from a user of a computing device; and any combinations thereof.

FIG. 6 illustrates another example of a portable handheld computing device in the form of a smartphone 600. Smartphone 600 includes a body 605, a button user input element 610, and a display element 615. Display element 615 may be a touch screen to provide a user with additional input interface capabilities. A computing device, such as smartphone 600, may be used in a variety of ways with respect to any of the methods described herein.

FIG. 7 illustrates one example diagrammatic representation of one implementation of a computing device 700. Computing device 700 includes a processing element 705, a memory 710, a display generator 715, a user input 720, a networking element 725, and a power supply 730. Processing element 705 includes circuitry and/or machine-executable instructions (e.g., in the form of firmware stored within a memory element included with and/or associated with processing element 705) for executing instructions for completing one or more tasks (e.g., tasks associated with one or more of the implementations, methodologies, features, aspects, and/or examples described herein). Examples of a processing element include, but are not limited to, a microprocessor, a microcontroller, one or more circuit elements capable of executing a machine-executable instruction, and any combinations thereof.

Memory 710 may be any device capable of storing data (e.g., data representing a image, a divided image, and/or one or more portions of an image; data representing information related to the division of one or more frames), machine-executable instructions, and/or other information related to one or more of the implementations, methodologies, features, aspects, and/or examples described herein. A memory, such as memory 710, may include a machine-readable hardware storage medium. Examples of a memory include, but are not limited to, a solid state memory, a flash memory, a random access memory (e.g., a static RAM “SRAM”, a dynamic RAM “DRAM”, etc.), magnetic memory (e.g., a hard disk, a tape, a floppy disk, etc.), an optical memory (e.g., a compact disc (CD), a digital video disc (DVD), a Blu-ray disc (BD); a readable, writeable, and/or re-writable disc, etc.), a read only memory (ROM), a programmable read-only memory (PROM), a field programmable read-only memory (FPROM), a one-time programmable non-volatile memory (OTP NVM), an erasable programmable read-only memory (EPROM), an electrically erasable programmable read-only memory (EEPROM), and any combinations thereof. Examples of a flash memory include, but are not limited to, a memory card (e.g., a MultiMediaCard (MMC), a secure digital (SD), a compact flash (CF), etc.), a USB flash drive, another flash memory, and any combinations thereof.

A memory may be removable from device 700. A memory, such as memory 710, may include and/or be associated with a memory access device. For example, a memory may include a medium for storage and an access device including one or more circuitry and/or other components for reading from and/or writing to the medium. In one such example, a memory includes a disc drive for reading an optical disc. In another example, a computing device may include a port (e.g., a Universal Serial Bus (USB) port) for accepting a memory component (e.g., a removable flash USB memory device).

A memory, such as memory 710, may include any information stored thereon. Examples of information that may be stored via a memory associated with a computing device include, but are not limited to, a video, a still image, a divided video, a divided image, one or more portions of a frame of a video, one or more portions of a still image, segment information, machine-executable instructions embodying any one or more of the aspects and/or methodologies of the present disclosure (e.g., instructions for displaying a divided image, instructions for providing an interface, etc.), an operating system for a computing device, an application program a program module, program data, a basic input/output system (BIOS) including basic routines that help to transfer information between components of a computing device, and any combinations thereof.

In one example, an image is stored on memory 710 after acquisition by a camera associated with computing device 700. In another example, an image is stored on memory 710 after acquisition via electronic transfer to computing device 700. Examples of electronic transfer include, but are not limited to, attachment to an electronic message (e.g., an email, an SMS/MMS message, a Snapchat message, a Facebook message, etc.), downloaded/saved from an online/Internet posting, transfer from a memory element removable from device 700, wireless transfer from another computing device, wired transfer from another computing device, and any combinations thereof.

Device 700 includes camera 715 connected to processing element 705 (and other components). Camera 715 may be utilized for acquiring one or more images for use with one or more of the implementations, embodiments, examples, etc. of the current disclosure. Examples of a camera include, but are not limited to, a still image camera, a video camera, and any combinations thereof.

Display component 720 is connected to processing element 705 for providing a display according to any one or more of the implementations, examples, aspects, etc. of the current disclosure (e.g., providing an interface, displaying separated display screens for each of a plurality of portions of an image, etc.). A display component 715 may include a display element, a driver circuitry, display adapter, a display generator, machine-executable instructions stored in a memory for execution by a processing element for displaying still and/or moving images on a screen, and/or other circuitry for generating one or more displayable images for display via a display element. Example display elements are discussed above. In one example, a display element is integrated with device 700 (e.g., a built-in LCD touch screen). In another example, a display element is associated with device 700 in a different fashion (e.g., an external LCD panel connected via a display adapter of display component 715).

User input 725 is configured to allow a user to input one or more commands, instructions, and/or other information to computing device 700. For example, user input 725 is connected to processing element 705 (and optionally to other components directly or indirectly via processing element 705) to allow a user to interface with computing device 700 (e.g., to actuate camera 715, to input instructions for dividing an image, to input instructions for designating a recipient of an image, and/or to perform one or more other aspects and/or methodologies of the present disclosure). Examples of a user input include, but are not limited to, a keyboard, a keypad, a screen displayable input (e.g., a screen displayable keyboard), a button, a toggle, a microphone (e.g., for receiving audio instructions), a pointing device, a joystick, a gamepad, a cursor control device (e.g., a mouse), a touchpad, an optical scanner, a video/image capture device (e.g., a camera), a touch screen of a display element, a pen device (e.g., a pen that interacts with a touch screen and/or a touchpad), and any combination thereof. It is noted that camera 715 and/or a touch screen of a display element of display component 720 may function also as an input element. It is also contemplated that one or more commands, data, and/or other information may be input to a computing device via a data transfer over a network and/or via a memory device (e.g., a removable memory device). A user input, such as user input 725, may be connected to computing device 700 via an external connector (e.g., an interface port).

External interface element 730 includes circuitry and/or machine-executable instructions (e.g., in the form of firmware stored within a memory element included with and/or associated with interface element 730) for communicating with one or more additional computing devices and/or connecting an external device to computing device 700. An external interface element, such as element 730, may include one or more external ports. In another example, an external interface element includes an antenna element for assisting with wireless communication. Examples of an external interface element include, but are not limited to, a network adapter, a Small Computer System Interface (SCSI), an advanced technology attachment interface (ATA), a serial ATA interface (SATA), an Industry Standard Architecture (ISA) interface, an extended ISA interface, a Peripheral Component Interface (PCI), a Universal Serial Bus (USB), an IEEE 1394 interface (FIREWIRE), and any combinations thereof. A network adapter includes circuitry and/or machine-executable instructions configured to connect a computing device, such as computing device 700, to a network.

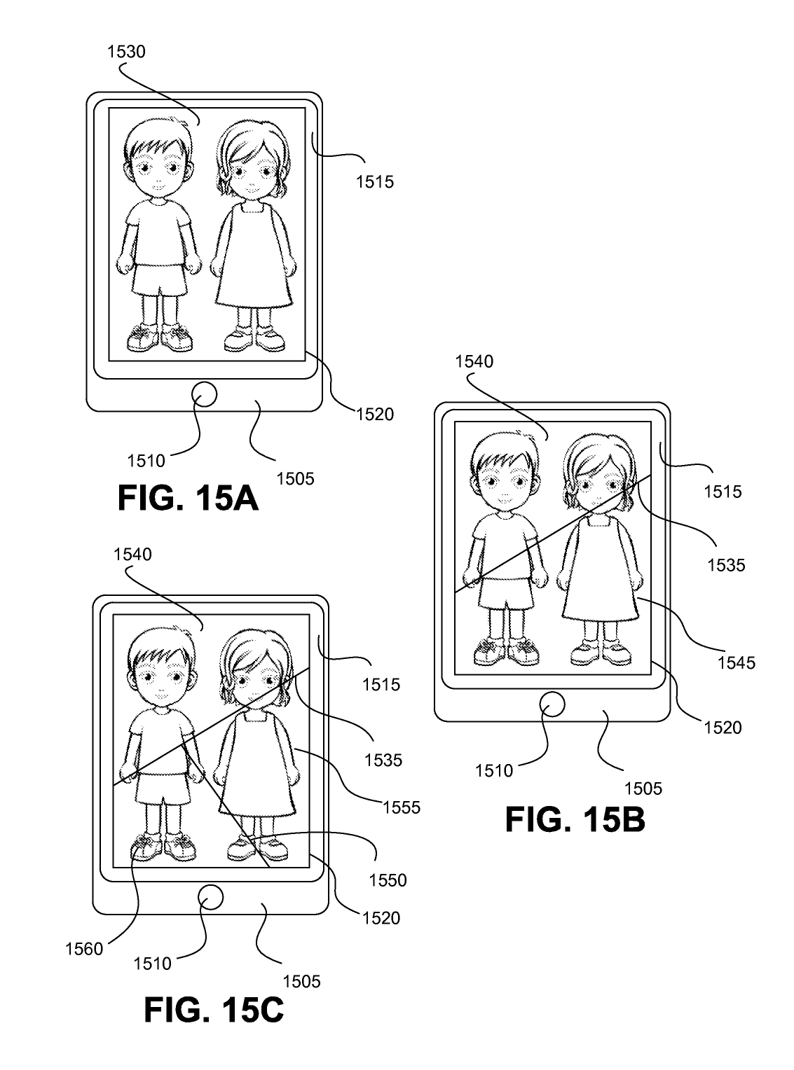

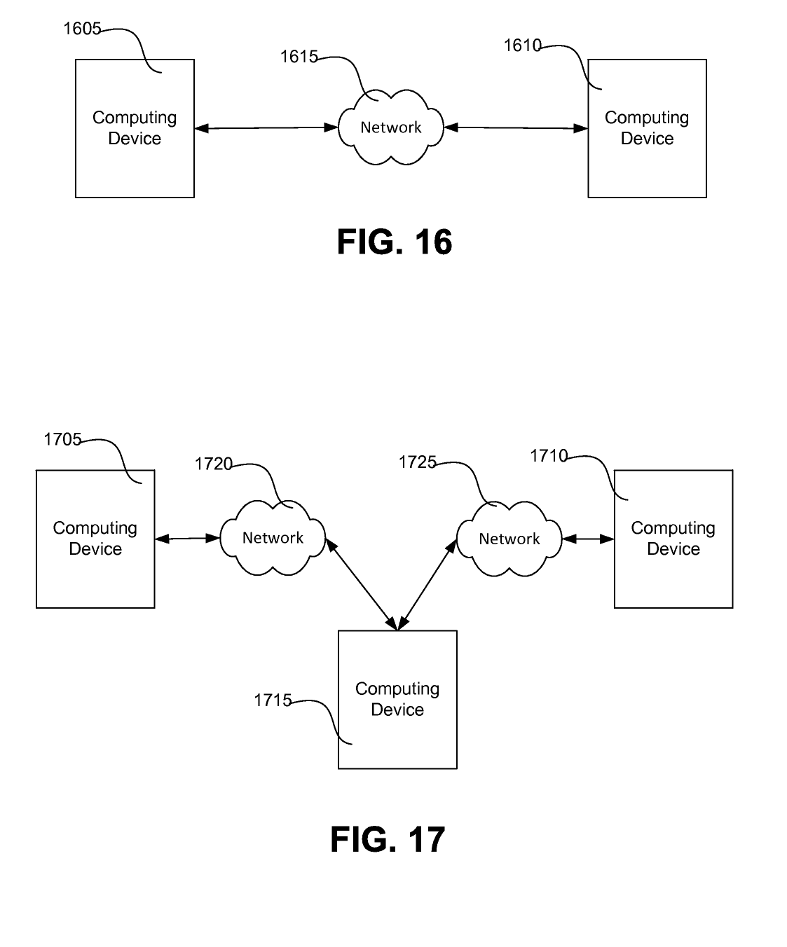

A network is a way for connecting two or more computing devices to each other for communicating information (e.g., data, machine-executable instructions, image files, video files, electronic messages, etc.). Examples of a network include, but are not limited to, a wide area network (e.g., the Internet, an enterprise network), a local area network (e.g., a network associated with an office, a building, a campus or other relatively small geographic space), a short distance network connection, a telephone network, a data network associated with a telephone/voice provider (e.g., a mobile communications provider data and/or voice network), another data network, a direct connection between two computing devices (e.g., a peer-to-peer connection), a proprietary service-provider network (e.g., a cable provider network), a wired connection, a wireless connection (e.g., a Bluetooth connection, a Wireless Fidelity (Wi-Fi) connection (such as an IEEE 802.11 connection), a Worldwide Interoperability for Microwave Access connection (WiMAX) (such as an IEEE 802.16 connection), a Global System for Mobile Communications connection (GSM), a Personal Communications Service (PCS) connection, a Code Division Multiplex Access connection (CDMA), and any combinations thereof. A network may employ one or more wired, one or more wireless, and/or one or more other modes of communication. A network may include any number of network segment types and/or network segments. In one example, a network connection between two computing devices may include a Wi-Fi connection between a sending computing device and a local router, an Internet Service Provider (ISP) owned network connecting the local router to the Internet, an Internet network (e.g., itself potentially having multiple network segments) connection connecting to one or more server computing devices and also to a wireless network (e.g., mobile phone) provider of a recipient computing device, and a telephone-service-provider network connecting the Internet to the recipient computing device. Examples of use of a network for transmitting a image, a divided image, and/or one or more portions of an image are discussed further below (e.g., with respect to FIGS. 15 and 16).

Power supply 730 is shown connected to other components of computing device 705 to provide power for operation of each component. Examples of a power supply include, but are not limited to, an internal power supply, an external power supply, a battery, a fuel cell, a connection to an alternating current power supply (e.g., a wall outlet, a power adapter, etc.), a connection to a direct current power supply (e.g., a wall outlet, a power adapter, etc.), and any combinations thereof.

Components of device 700 (processing element 705, memory 710, camera 715, display component 720, user input 725, interface element 730, power supply 735) are shown as single components. A computing device may include multiple components of the same type. A function of any one component may be performed by any number of the same components and/or in conjunction with another component. For example, it is contemplated that the functionality of any two or more of processing element 705, memory 710, camera 715, display component 720, user input 725, interface element 730, power supply 735, and another component of a computing device may be combined in an integrated circuit. In one such example, a processor (e.g., processing element 705) may include a memory for storing one or more machine executable instructions for performing one or more aspects and/or methodologies of the present disclosure. Functionality of any one or more components may also be distributed across multiple computing devices. Such distribution may be in different geographic locations (e.g., connected via a network). Components of device 700 are shown as internal components to device 700. A component of a computing device, such as device 700, may be associated with the computing device in a way other than by being internally connected.

Components of computing device 700 are shown connected to other components. Examples of ways to connect components of a computing device include, but are not limited to, a bus, a component connection interface, another type of connection, and/or any combinations thereof. Examples of a bus and/or component connection interface include, but are not limited to, a memory bus, a memory controller, a peripheral bus, a local bus, a parallel bus, a serial bus, a SCSI interface, an ATA interface, an SATA interface, an ISA interface, a PCI interface, a USB interface, a FIREWIRE interface, and any combinations thereof. Various bus architectures are known. Select connections and components in device 700 are shown. For clarity, other connections and various other well-known components (e.g., an audio speaker, a printer, have been omitted and may be included in a computing device. Additionally, a computing device may omit in certain implementations one or more of the shown components.

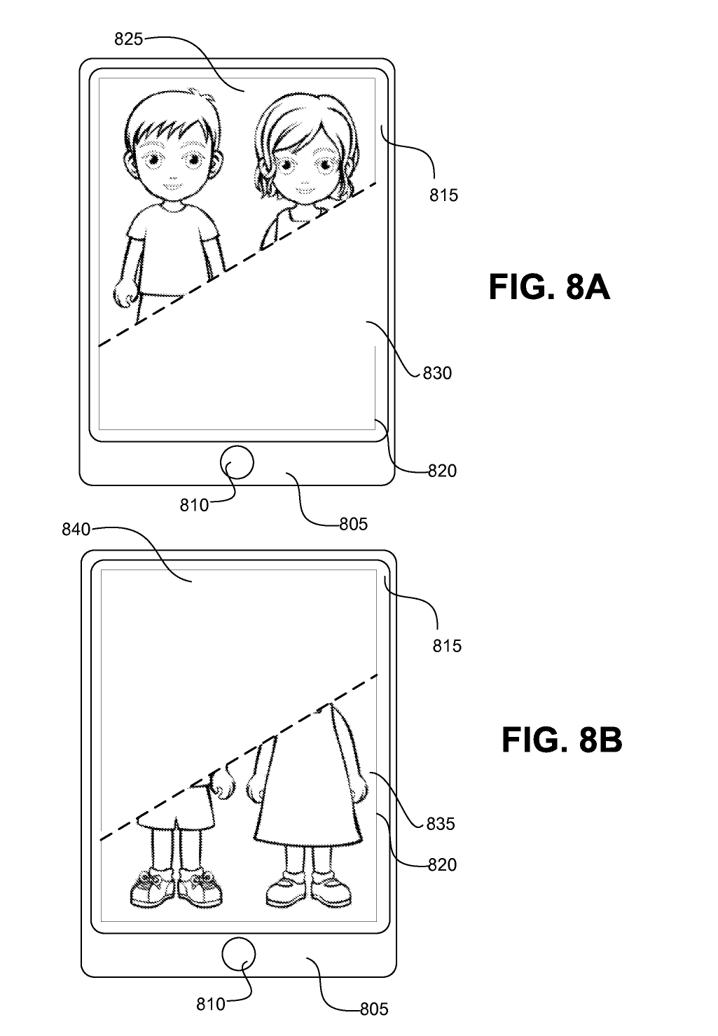

FIGS. 8A and 8B illustrate one exemplary implementation of a display of a plurality of portions of an electronic image via a computing device. For the sake of brevity, some of the details, concepts, aspects, features, characteristics, examples, and/or alternatives discussed with respect to other implementations in this disclosure are not repeated in the discussion of FIGS. 8A to 8F. Any one or more of the like details, concepts, aspects, features, characteristics, examples, and alternatives may apply similarly here, except where noted.

Computing device 805 (here shown as an example smartphone implementation) includes a user input 810. Also, device 805 includes a display element 815 (e.g., a touch screen LCD display). Display element 815 is shown displaying an image display region 820 having an area inside the perimeter of the region. In this example, image display region 820 is shown having a rectangular shape representative of an electronic image to be displayed. In FIG. 8A, a portion 825 of an electronic image is displayed in a subregion of image display region 820. In this example, the subregion corresponds to the location of portion 825 in the electronic image. A substitute portion 830 is displayed in the subregion(s) of the image display region that do not correspond to portion 825 (e.g., the subregion that corresponds to one or more additional portions of the electronic image.

FIG. 8B illustrates the separated display of portion 835 of the electronic image via device 805 in a subregion of image display region 820 that corresponds to the location of portion 835 in the electronic image. A substitute portion 840 is displayed in the subregion of the image display region corresponding to portion 825. Substitute portions 830 and 840 are shown as white blank polygons. Examples of other substitute portions are discussed above. In another example, a non-display (e.g., a default state for no data) of display element 815 may be used in place of a white blank polygon. Portions 825 and 835 are not displayed at the same time.

It is noted that the dashed line 845 in FIGS. 8A and 8B is shown (as above) to aid in the visualization of the subregions and separated display of portions 825 and 835. The display of portions 825 and 835 in actual implementation may omit lines, such as dashed line 845. In one example, the display of portions 825 and 835 are repeated alternately.

FIGS. 9A and 9B show an exemplary alternating display of two portions of an example electronic image. FIG. 9A illustrates an image display region 905 having an area bounded by a perimeter 910. An image portion 915 is displayed in a subregion of the area that corresponds to portion 915. A substitute portion 920 is displayed in a subregion of the area that corresponds to portions other than portion 915. Substitute portion 920 is shown as a greyscale polygon-shaped portion. FIG. 9B illustrates image display region 905 with an image portion 925 displayed in a subregion of the area that corresponds to portion 925. A substitute portion 930 is displayed in a subregion of the area that corresponds to portions other than portion 925 (i.e., the subregion corresponding to portion 915). Substitute portion 930 is shown as a greyscale polygon-shaped portion.

FIGS. 10A and 10B show an alternating display of two portions of an electronic image. FIG. 10A illustrates an image display region 1005 having an area bounded by a perimeter 1010. An image portion 1015 is displayed in a subregion of the area that corresponds to portion 1015. A substitute portion 1020 is displayed in a subregion of the area that corresponds to portions other than portion 1015. FIG. 10B illustrates image display region 1005 with an image portion 1025 displayed in a subregion of the area that corresponds to portion 1025. A substitute portion 1030 is displayed in a subregion of the area that corresponds to portions other than portion 1025 (i.e., the subregion corresponding to portion 1015). Substitute portion 1020 is shown as a blurred polygon-shaped version of portion 1025. Substitute portion 1030 is shown as a blurred polygon-shaped version of portion 1015.

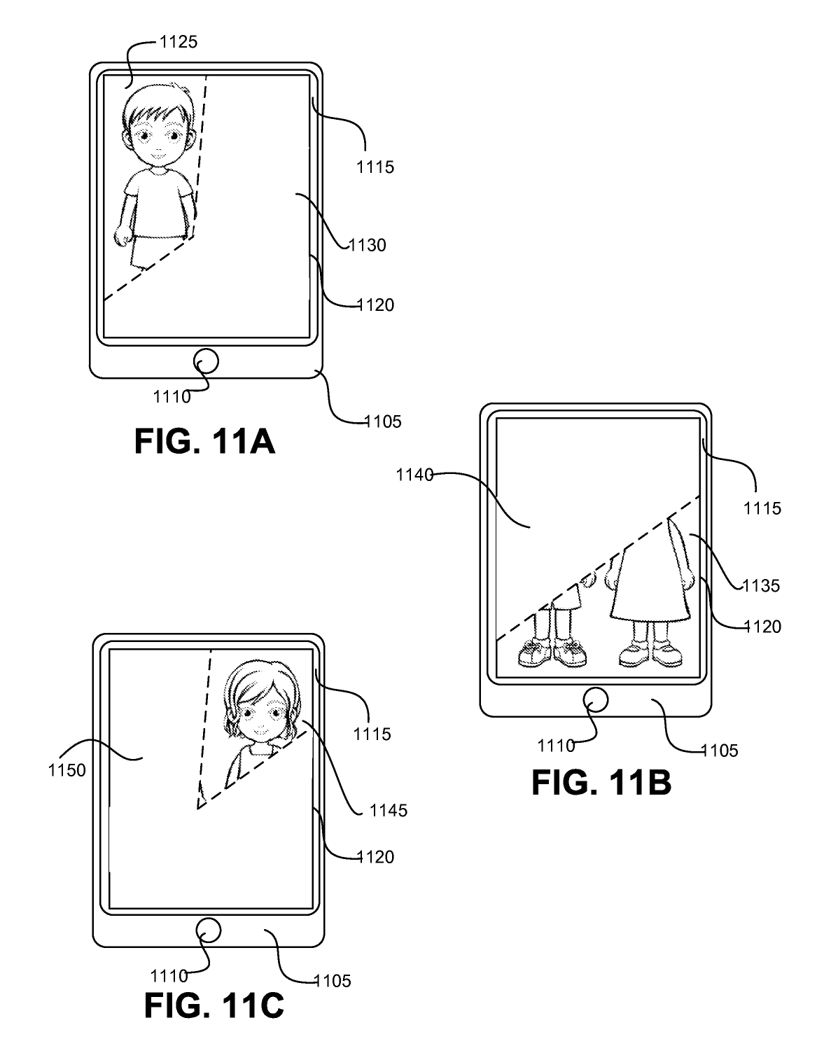

FIGS. 11A to 11C illustrate another example of a divided electronic image having a plurality of portions displayed separately via a computing device. A computing device 1105 includes a user input element 1110 (here, shown as a button) and a display element 1115 (e.g., an LCD touch screen display). Display element 1115 is shown in FIG. 11A displaying an image display region 1120 having a portion 1125 of the electronic image displayed in a subregion of image display region 1120 (e.g., a subregion that corresponds to the location of portion 1125 in the original electronic image relative to other portions of the image). A substitute portion 1130 is displayed in one or more subregions of image display region 1120 corresponding to a location of one or more other portions of the electronic image that are not displayed at the same time as portion 1125. In this example, substitute portion 1130 is shown as a white-colored polygon. Alternative examples of characteristics of a substitute portion are discussed above. Image display region 1120 is shown in FIGS. 11A to 11C with a visible outline (in this example, a rectangular outline) and a dashed line to separate a corresponding portion from one or more substitute portions. This is done for assistance in visualizing the image display region 1120 and the location of subregions for each of the plurality of portions. Such outlines and/or dashed lines may be omitted in any of the implementations of a display of a plurality of portions of an electronic image.

In FIG. 11B, a portion 1135 of the electronic image is displayed in a subregion of image display region 1120 (e.g., a subregion that corresponds to the location of portion 1135 in the original electronic image relative to other portions of the image). A substitute portion 1140 is displayed in one or more subregions of image display region 1120 corresponding to a location of one or more other portions of the electronic image (e.g., portion 1125, etc.) that are not displayed at the same time as portion 1135.

In FIG. 11C, a portion 1145 of the electronic image is displayed in a subregion of image display region 1120 (e.g., a subregion that corresponds to the location of portion 1145 in the original electronic image relative to other portions of the image). A substitute portion 1150 is displayed in one or more subregions of image display region 1120 corresponding to a location of one or more other portions of the electronic image (e.g., portion 1125, 1135) that are not displayed at the same time as portion 1145. Portions 1125, 1135, 1145 are not displayed at the same time. In one example, the separate display of portions 1125, 1135, 1145 are automatically repeated. In one such example, the automatic repeating continues until the end of a termination event occurs. Examples of a termination event include, but are not limited to, expiration of a predetermined amount of time, expiration of a predetermined number of repeat displays, receipt of a termination command from a user of a computing device used to display the plurality of portions, and any combinations thereof. Examples of a termination command include, but are not limited to, detecting an actuation of a touch screen depression by a user, detecting an actuation of an input element by a user, and any combinations thereof.

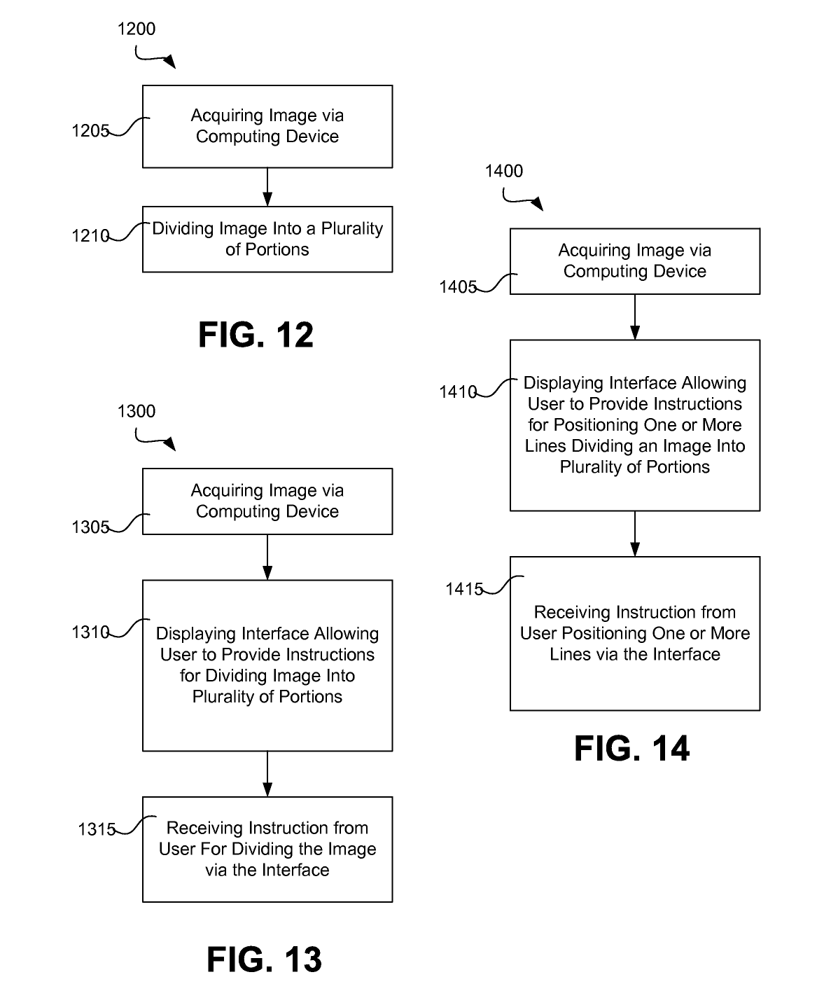

FIG. 12 illustrates one exemplary implementation of a method 1200 of dividing an image into a plurality of portions. For the sake of brevity, some of the details, concepts, aspects, features, characteristics, examples, and/or alternatives discussed with respect to other implementations in this disclosure (e.g., related to the division of an image into a plurality of portions) are not repeated in the discussion of FIG. 12. Any one or more of the like details, concepts, aspects, features, characteristics, examples, and alternatives may apply similarly here, except where noted. At step 1205, an image is acquired via a computing device.

Acquisition of an image can occur in a variety of ways. Example ways to acquire an image include, but are not limited to, using a camera built into a computing device to capture an image, using a camera associated with a computing device to capture an image, accessing an image stored on a memory element of a computing device, accessing an image stored on a memory element associated with a computing device, receiving an image over a network connection (e.g., as an attachment to an electronic message, as a download from an Internet posting, etc.), and any combinations thereof. In one example, an image is captured using a camera and stored (e.g., temporarily in RAM or other volatile memory, as an image file in non-volatile memory, etc.) in a memory element of a computing device from where it is acquired. In another example, an image previously saved as an image file on a memory element of a computing device is acquired by accessing the image file.

At step 1210, each image of at least a set of the images of an image is divided into a plurality of portions. Any number of images may be divided. The dividing of an image into a plurality of portions (e.g., an automated dividing, a dividing via a user interface, etc.) can occur at any of a variety of computing devices and/or times with respect to the acquisition of the image. In one example, an image is acquired via a computing device and the dividing occurs at the same computing device. In another example, an image is acquired via a computing device and the dividing occurs at the same computing device prior to transmitting the divided image to another computing device. In still another example, an image is acquired via a computing device and transmitted to another computing device at which the dividing occurs (e.g., at an intermediate server computing device, at a recipient computing device).

How the specific portions of an image are determined by a user and/or by an automated function may vary based on a desired outcome. Example considerations for determining how an image is divided include, but are not limited to, a random placement, an entertainment purpose, ensuring separation of identifying information that in itself identifies a subject included in the image from other aspects of the image (e.g., via division such that identifying information is in one portion and other aspects are included in one or more other portions), a privacy concern, locating all or a part of a face of a subject included in the image in one portion and other aspects of the image in one or more other portions, preventing screen capture of two or more aspects of an image (e.g., via placing the two or more aspects in separate portions), another reason of a user, another reason of a system designer, and any combinations thereof.

As discussed above, each portion of a divided image corresponds to a subregion of the area of the original image. During a later separated display of the portions of an image, corresponding subregion information may be utilized. For example, a display of a portion of an image may position the portion such that it is located on the display in a subregion of the display that correlates to the original subregion of the image. In one such example, each portion can be positioned in the display such that the overall impression from the separated views of all portions may appear similar to the original image (e.g., successive display of multiple portions of multiple images may appear similar to a viewer as the original image without division of images). In other examples, display of one or more portions may position a portion in a subregion of the image display region that does not correlate with the original position of the subregion of the original image from where the portion derived.

As discussed above, one or more portions of a divided image may have an image parameter modified. Example image parameters are discussed above. In one example, an interface can be provided to a user of a computing device for modifying one or more image parameters of one or more portions of an image. Such an interface can provide the user with an ability to input instructions for modifying an image parameter. A user may utilize an input element to provide such an instruction via the interface. Such instructions may be received via the computing device. In another example, one or more image parameters of one or more portions may be automatically modified (e.g., via a sending computing device, via a recipient computing device, and/or via an intermediate computing device).

Additional visual information may be added to an image, an image, and/or one or more portions of a divided image. Examples of additional visual information include, but are not limited to, a textual information, a graphical information, and any combinations thereof. In one example, one or more additional visual information elements is added to an image and/or portion of an image prior to the image being divided such that the one or more additional visual information elements may be divided along with the image according to one or more of the implementations discussed herein for dividing an image. In another example, one or more additional visual information elements is added to an image and/or portion of an image after the image is divided. A user interface may be provided at a computing device to allow a user to add one or more additional visual information. A user may utilize an input element to provide an instruction regarding an additional visual information via the interface. An instruction may be received via the computing device. In another example, one or more additional visual information is added automatically (e.g., via a sending computing device, via a recipient computing device, and/or via an intermediate computing device)

As discussed above, an interface may also be provided that allows a user to provide an instruction for defining a characteristic of one or more substitute portions. A user may utilize an input element to provide such an instruction via the interface. An instruction may be received via the computing device.

A divided image, regardless of which process is used to divide the image, can be handled in a variety of ways after it has been divided. Example ways for handling a divided image include, but are not limited to, displaying one or more of the divided portions of an image on the same computing device used to divide the image, displaying one or more of the divided portions of an image on a computing device that is different from the computing device used to divide the image, transmitting the divided image from the computing device used to divide the image to a second computing device, storing the divided image on a memory element (e.g., a memory element part of the computing device used to divide the image, a memory element associated (e.g., a cloud storage device) with the computing device used to divide the image, a memory element of a computing device not used to divide the image, etc.), uploading a divided image to a social networking service (e.g., Facebook, Instagram, etc.), and any combinations thereof. Transmission of a divided image may occur shortly after the dividing and/or at a later time. Examples of a transmission include, but are not limited to, uploading the divided image to a computing device of a service provider affiliated with the dividing of the image (e.g., a service provider that provided machine-executable instructions, such as in the form of an “app” and/or webservice, for dividing the image), uploading the divided image to a computing device of a social network provider (e.g., Facebook, Instagram, etc.), attaching the divided image to an electronic message (e.g., an e-mail, an electronic message specifically designed to transfer the divided image, etc.), transmitting the divided image to a computing device of an intended recipient of the divided image, transmitting the divided image to an intermediate computing device (e.g., a server computing device), and any combinations thereof.

FIG. 13 illustrates another exemplary implementation of a method 1300 of dividing an image into a plurality of portions. Exemplary details, concepts, aspects, features, characteristics, examples, and/or alternatives for portions of an image, interfaces for dividing an image, and the division of images are discussed elsewhere in the current disclosure (e.g., with respect to FIGS. 1A to 1D, 2A to 2F, 3A, 3B, 11) and may be applicable where appropriate in this implementation except where expressly described otherwise. At step 1305, an image is acquired via a computing device.

At step 1310, an interface is provided to a user of the computing device. The interface is configured to allow the user to provide instructions for dividing the image into a plurality of portions. The interface may utilize one or more representations of an image.

A user may interact with the interface to provide the instructions for dividing. In one example, one or more input elements of a computing device may be utilized to provide instructions for dividing to a computing device. The computing device receives the instructions from the user and may utilize the instructions for dividing the image (e.g., at the computing device prior to transmission to another computing device, at another computing device after transmission to the other computing device, etc.). Example input elements are discussed above with respect to FIG. 7. In one example, a user interacts with the interface including actuation of a touch screen of a display element to provide instructions for dividing an image of an image and the computing device receives the instructions via the actuation of the touch screen. Other example user input element actuations and combinations of actuations will be understood and applicable depending on the particular computing device, interface, display element, etc.

One or more additional interfaces (e.g., to allow a user to provide an instruction for modification of an image parameter of one or more portions of an image, to allow a user to define one or more characteristics of one or more substitute portions, and/or to allow a user to provide an instruction for adding additional visual information to an image and/or one or more portions of a divided image) may be provided. In one example, one or more interfaces together provide the functionality of a plurality of interfaces. In another example, each interface is designed to receive one type of instruction from a user.

At step 1315, an instruction for dividing an image is received via the interface. The received instruction can be utilized to divide one or more of the images into a plurality of portions. For example, one or more locations for division of an image may be received. In one example, a plurality of portions is defined by positioning one or more lines via an interface. In another example, a plurality of portions is defined by defining a plurality of polygon-shaped portions.

FIG. 14 illustrates yet another exemplary implementation of a method 1400 of dividing an image into a plurality of portions. Exemplary details, concepts, aspects, features, characteristics, examples, and/or alternatives for portions of an image, interfaces for dividing an image, and the division of images (e.g., using one or more lines) are discussed above (e.g., with respect to FIGS. 1A to 1D, 2A to 2F, 3A, 3B, 11, 12) and may be applicable where appropriate in this implementation except where expressly described otherwise. At step 1405, an image is acquired via a computing device. Aspects, features, and examples of acquiring an image are discussed above (e.g., with respect to method 1100 of FIG. 11).

At step 1410, an interface is provided to a user of the computing device. The interface is configured to allow the user to provide instructions for positioning one or more lines dividing the image into a plurality of portions.

At step 1415, an instruction for positioning one or more lines is received for dividing an image into portions. The received instruction for positioning one or more lines can be utilized to divide one or more of the images of the image into a plurality of portions. Example ways to allow a user to position a line on an image include, but are not limited to, accepting instruction from a user via a user input device associated with (e.g., directly part of and/or connected to) a computing device, displaying an image via a display element and positioning a line across a part of the image, displaying an image via a display element and displaying a line via the same display element (the line having changeable position and/or length), and any combinations thereof.

One or more additional interfaces (e.g., to allow a user to provide an instruction for modification of an image parameter of one or more portions of an image, to allow a user to define one or more characteristics of one or more substitute portions, and/or to allow a user to provide an instruction for adding additional visual information to an image, an image, and/or one or more portions of a divided image) may be provided. In one example, one or more interfaces together provide the functionality of a plurality of interfaces. In another example, each interface is designed to receive one type of instruction from a user.

FIGS. 15A to 15C illustrate one exemplary implementation of an interface for dividing an image. FIG. 15A shows a computing device 1505 having an input element 1510 and a display screen of a display element 1515. An interface 1520 is provided via the display element 1515. In one example, display element 1515 includes a touch screen capability that can provide a user an ability to provide one or more inputs to computing device 1505. Interface 1520 is shown displaying an image 1530. Interface 1520 is configured (e.g., via machine-executable instructions, interaction with display element 1515, and interaction with one or more user inputs, such as input 1510 and/or a touch screen capability of display element 1515) to allow a user of computing device 1505 to position one or more lines to divide image 1530.

FIG. 15B shows a line 1535 positioned via interface 1520 to divide image 1530 into a portion 1540 and a portion 1545. Line 1535 is shown connecting two edges of image 1530. FIG. 15C shows a line 1550 positioned via interface 1520 to divide portion 1545 into a portion 1555 and a portion 1560. A line positioned at a division of two or more portions, such as line 1535 and/or line 1550, may extend beyond an edge of an image and/or beyond an intersection of two lines in a display of an interface (e.g., even though such extension may not be necessary to define a division of an image).

As discussed above, an acquired image and/or a divided image of any one of the various embodiment, implementations, and/or examples disclosed herein may be transmitted from one computer (e.g., a sending computing device) to another computing device (e.g., an intermediate computing device, such as a server computer, and/or a recipient computing device). Transmission from one computing device to another computing device may occur over a network.

FIG. 16 illustrates one example of a networking environment including a first computing device 1605 connected to a second computing device 1610 via a network 1615. Examples of a computing device are discussed above. Each of computing devices 1605 and 1610 may include a networking element for allowing connection to network 1615.

As discussed in the various examples above, an image may be acquired via computing device 1605. In one example, the image may be divided at computing device 1605 prior to transmitting from computing device 1605. In another example, the image may be divided at computing device 1610 (e.g., prior to display of the image via computing device 1610).

An image, a divided image, one or more portions of image, segment information detailing a division of image, and/or other information may be transmitted from computing device 1605 to computing device 1610 over network 1615. In one example, a divided image (e.g., as a plurality of portions each as separate files, as an image file and segment information detailing the division into a plurality of portions, etc.) is transmitted from computing device 1605 as part of a single transmission (e.g., as one set of data transfer). In another example, different portions of a divided image are transmitted separately from computing device 1605 as separate files. In yet another example, an image file is transmitted from computing device 1605 separately from segment information detailing the division into a plurality of portions. Separation during transmission may reduce the ability for interception of an entire image prior to the information being received by a recipient computing device, such as computing device 1610. In still another example, an image is streamed from computing device 1605 (e.g., as a single stream, as multiple streams).

FIG. 17 illustrates another example of a networking environment having a computing device 1705 and a computing device 1710. An image, a divided image, one or more portions of image, segment information detailing a division of an image, and/or other information may be transmitted from computing device 1705 to computing device 1710. An intermediate computing device 1715 exists between computing device 1705 and computing device 1710. In one example, computing device 1715 is one or more server computing devices. In one such example, computing device 1715 is operated by an entity that provides a service to users of computing device 1705 and computing device 1710 that allows those users to perform any one or more of the embodiments, implementations, features, aspects, etc. for dividing and image, transmitting an image, and/or displaying an image as disclosed herein. Computing device 1705 is connected to computing device 1715 via a network 1720. Computing device 1710 is connected to computing device 1715 via a network 1725. In one example, networks 1720 and 1725 include one or more network segments shared between networks 1720 and 1725. In another example, networks 1720 and 1725 do not share a network segment.

An image, a divided image, one or more portions of an image, segment information detailing a division of an image, and/or other information may be transmitted from computing device 1705 to computing device 1715 and then to computing device 1710.

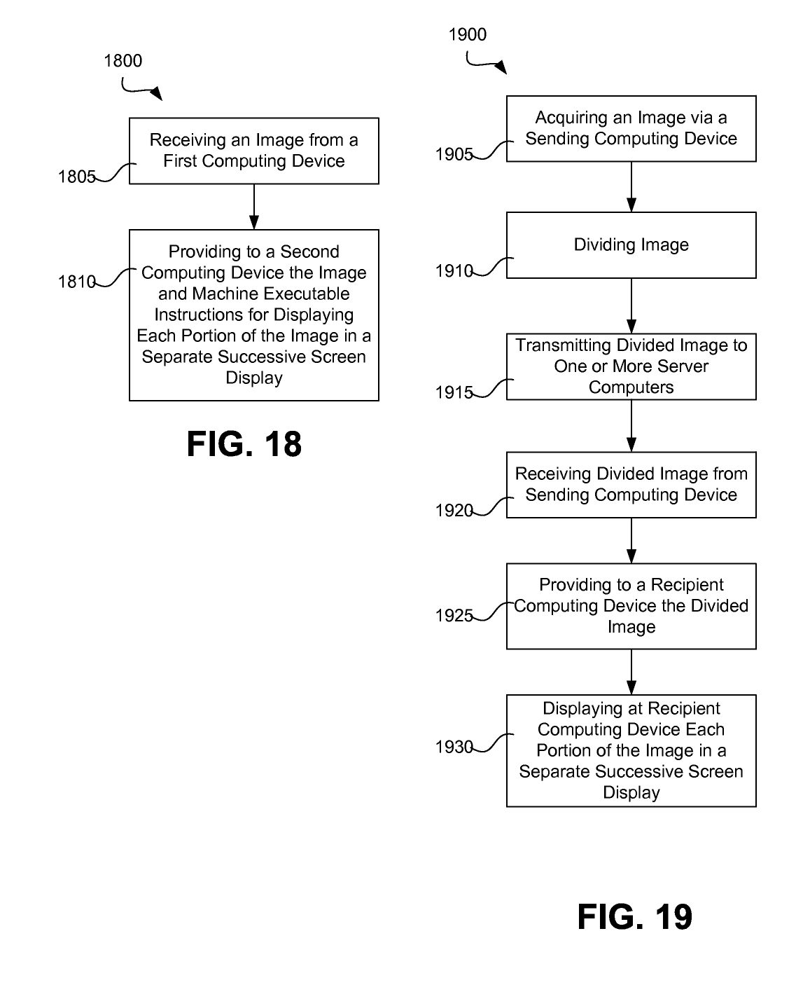

FIG. 18 illustrates one exemplary implementation of a method 1800 of transmitting an image. At step 1805, an image is received by a first computing device. Reception may occur over a network (e.g., as described in examples above with respect to FIGS. 15, 16) or via another form of transmission to the computing device. In one example, the first computing device is one or more server computing devices of a service provider involved in receiving an image (e.g., a divided image and/or an undivided image for dividing prior to display) and providing a recipient user with the image for display according to one or more of the implementations, examples, aspects, etc. of separated display disclosed herein.

At step 1810, the image and machine-executable instructions for displaying each portion of an image in a separate successive screen display are provided by the first computing device (e.g., one or more server computing devices) to a recipient computing device. As discussed herein, there are a variety of ways to divide an image and a variety of ways to display successive screen displays of separated portions of an image. The machine-executable instructions provided to the recipient computing device may include instructions for displaying each portion separately having any one or more of the features, aspects, etc. of any one or more of the implementations of displaying portions of an image of an image disclosed herein. Examples of instructions for inclusion in machine-executable instructions for displaying each portion of each image of at least a set of image in a separate successive screen display include, but are not limited to, instructions for providing an interface for displaying a divided image via a display element of a computing device, instructions for providing another type of interface, instructions for providing an image display region, instructions for automatically dividing image into a plurality of portions, instructions for modifying an image parameter of one or more portions of an image, data representing one or more additional visual information, segment information (e.g., defining one or more locations, subregions, etc. for a plurality of portions of image), machine-executable instructions for receiving a user instruction via an interface, and any combinations thereof.

In one example, the machine-executable instructions include segment information (e.g., segment information that can be used in conjunction with additional machine-executable instructions provided at a prior time to the second computing device to display the separated portions of the images). In another example, the machine-executable instructions include segment information provided at about the same time as the image to the second computer and other machine-executable instructions (e.g., in the form of a downloadable “app”) provided to the second computer at a time prior to the image and segment information (e.g., via an “app” download Internet location). In another example, a segment of machine-executable instructions may be part of an image display codec, part of an operating system, part of a package of an operating system, and/or another application of a computing device. In yet another example, one or more functions for displaying an interface or other displayable element according to any of the aspects, methodologies, and/or implementations of the present disclosure may be performed as a hardware function of a graphics processing unit (GPU and/or CPU).

Any part of the machine-executable instructions may be provided to the recipient computing device at the same time or relatively close in time as the time of providing the image to the recipient computing device. In certain implementations, at least a part of the machine-executable instructions are provided at a time prior to the provision of the image to the recipient computing device. In one example, at least a part of the machine-executable instructions for displaying each portion of each image of at least a set of image in a separate successive screen display and/or displaying an interface is provided to a recipient computing device as a downloadable application (e.g., an “app”) for execution in conjunction with the image and segment information provided with the image (e.g., as a part of the machine-executable instructions). In one such example, a downloadable application is provided to the recipient computing device by an entity that is also responsible for providing the image to the recipient device (e.g., via one or more server computers of a service provider for sending, dividing, receiving, and/or displaying an image). A downloadable application can be provided to a recipient computing device by an entity via any of a variety of ways. Example ways for an entity to provide a downloadable application to a recipient computing device include, but are not limited to, providing access to one or more server computing devices having the application and being operated by the entity and/or an agent of the entity, the entity and/or an agent of the entity providing access to the application via a third-party application download site (e.g., Apple's App Store, Google's Android App Store, etc.), and any combinations thereof.

In another example, at least a part of the machine-executable instructions for displaying each portion of each image of at least a set of image in a separate successive screen display and/or displaying an interface is provided to a recipient computing device via access by the recipient device to a website that actively provides the separated display of the portions via an interaction with the website and one or more Internet browser applications (or a proprietary application designed for interaction with the website) on the recipient computing device.

As discussed herein, an image may be divided at one or more of a variety of points prior to display of a plurality of portions of one or more images in separate screen displays. Examples of a point prior to display for dividing an image include, but are not limited to, dividing one or more images into a plurality of portions using a sending computing device (e.g., a computing device that acquires the image), dividing one or more images into a plurality of portions using an intermediate computing device (e.g., the first computing device of step 1805, one or more server computers, etc.), dividing one or more images into a plurality of portions using a recipient computing device (e.g., the recipient computing device of step 1810), and any combinations thereof. In one example, the image provided to the recipient computing device is a divided image. In one such example, the machine-executable instructions include segment information. In another example, the image received by the first computing device at step 1805 is a divided image. In yet another example, the image provided to the recipient computing device at step 1810 is undivided and one or more of the images of the image is divided into a plurality of portions (e.g., via an automated process) at the recipient computing device prior to display via the recipient computing device according to step 1810. In one such example, the machine-executable instructions provided to the recipient computing device (e.g., at a time prior to the provision of the image (for example, as an app)) include instructions for how to divide one or more images into a plurality of portions (e.g., via an automated process).

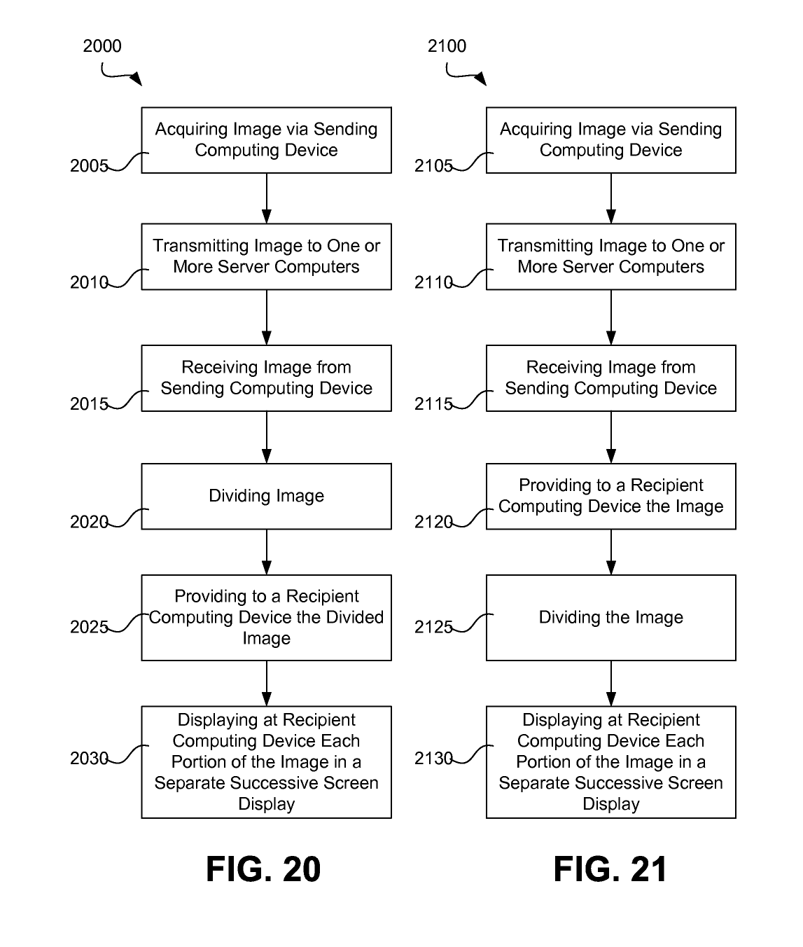

FIGS. 19, 20, and 21 illustrate exemplary implementations of methods of displaying a divided image. Aspects, features, alternatives, examples, and concepts discussed herein with respect to the various implementations for acquiring an image, dividing an image, providing an interface, transmitting an image and/or a divided image, receiving an image and/or a divided image, displaying each of a plurality of portions of each image in a separate screen display, etc. may also be applicable to the methods described with respect to FIGS. 19, 20, and/or 21. The exemplary implementations of methods discussed with respect to FIGS. 19, 20, and 21 include one or more server computing devices as intermediate computing devices (e.g., as shown in FIG. 17). Similar examples to those discussed with respect to FIGS. 19 and 21 are contemplated with no intermediate computing devices (e.g., as shown in FIG. 16), such as in a peer-to-peer environment.

FIG. 19 illustrates one exemplary implementation of a method 1900 of displaying a divided image. At step 1905, an image is acquired via a sending computing device. At step 1910, the image is divided into a plurality of portions at the sending computing device. At step 1915, a divided image is transmitted to one or more server computing devices. At step 1920, the divided image is received by the one or more server computing devices. At step 1925, the divided image is provided to a recipient computing device (e.g., with machine-executable instructions for displaying each portion of the divided image in a separate screen display). At step 1930, each portion of the image is displayed in a separate successive screen display via the recipient computing device.

FIG. 20 illustrates another exemplary implementation of a method 2000 of displaying a divided image. At step 2005, an image is acquired via a sending computing device. At step 2010, the image is transmitted to one or more server computing devices. At step 2015, the image is received by the one or more server computing devices. At step 2020, the image is divided into a plurality of portions at the one or more server computing devices. At step 2025, the divided image is provided to a recipient computing device (e.g., with machine-executable instructions for displaying each portion of the divided image in a separate screen display). At step 2030, each portion of the image is displayed in a separate successive screen display via the recipient computing device.

FIG. 21 illustrates yet another exemplary implementation of a method 2100 of a divided image. At step 2005, an image is acquired via a sending computing device. At step 2010, the image is transmitted to one or more server computing devices. At step 2015, the image is received by the one or more server computing devices. At step 2020, the image is provided to a recipient computing device. At step 2025, the image is divided into a plurality of portions at the recipient computing device. At step 2030, each portion of the image is displayed in a separate successive screen display via the recipient computing device.

At a sending computing device that transmits an image for separated display via a recipient computing device, an interface may be provided for allowing a user of the sending computing device to designate one or more recipients for the image. Such an interface may be provided before and/or after an interface provided at the sending computing device for dividing an image and may be provided before and/or after an interface provided at the sending computing device for acquiring an image. Any combination of interfaces for designating a recipient; for acquiring an image; for modifying one or more portions of an image of an image; for dividing an image (e.g., via a representation of image); for providing one or more additional information to an image, a divided image, and/or a portion of an image; and for other functions may be provided in any order that accommodates the desired function of the interface. Additionally, any of the interfaces may be provided as a combined interface (e.g., such that the combined interface displays combined functionality at the same time to a user). Examples of ordering for interfaces include, but are not limited to, providing an interface for acquiring an image prior to providing an interface for designating one or more recipients, providing an interface for acquiring an image after providing an interface for designating one or more recipients, providing an interface for dividing an image prior to providing an interface for designating one or more recipients, providing an interface for dividing an image after providing an interface for designating one or more recipients, providing an interface for allowing a user to modify an image parameter of one or more portions prior to providing an interface for designating one or more recipients, providing an interface for allowing a user to modify an image parameter of one or more portions after providing an interface for designating one or more recipients, providing an interface for inputting one or more additional visual information prior to providing an interface for designating one or more recipients, providing an interface for inputting one or more visual information after providing an interface for designating one or more recipients, and any combinations thereof. Examples of ways to combine functionality in a common screen display interface include, but are not limited to, using different portions of a screen display of an interface for different functionality, superimposing a user actuatable element of a screen display over another element of a screen display (e.g., superimposing user actuatable elements for performing one or more functions over an image), and any combinations thereof. Examples of a user actuatable element include but are not limited to, a graphical element, a textual element, an image element, an element selectable using a pointer device, an element selectable using a touch screen actuation, and any combinations thereof.

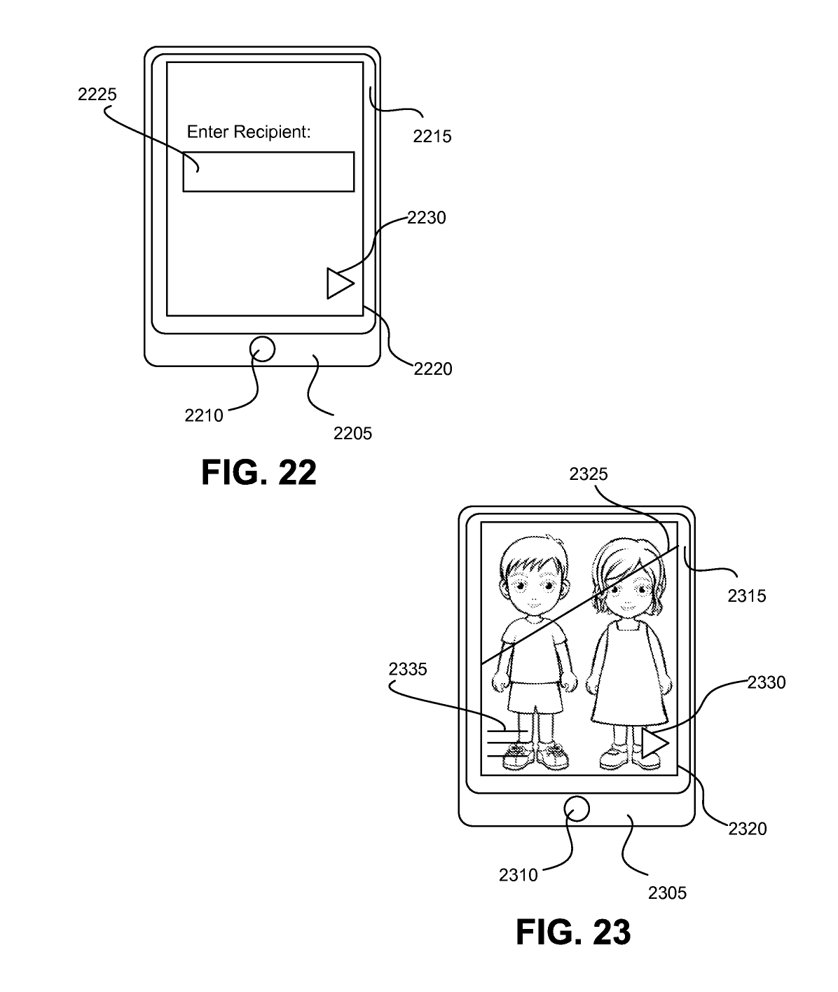

In one exemplary aspect, an interface for allowing a user to designate a recipient may include any interface element that allows the input and/or selection of one or more recipients for an image (e.g., an acquired image, a divided image, etc.). Examples of an interface element that allows the input and/or selection of one or more recipients include, but are not limited to, a text entry element, a list of possible recipients for selection (e.g., recent recipients, recipients in an address book, etc.), a search element (e.g., for searching an address book; for searching other users of a system for dividing, transmitting, and/or displaying a divided image; etc.), a lookup element for looking up a recipient, a graphical element, a textual element, and any combinations thereof. FIGS. 22 and 23 illustrate exemplary interfaces that may be utilized in one or more of the implementations of a sending computing device and/or dividing of an image according to the current disclosure.

FIG. 22 illustrates one exemplary implementation of an interface for designating one or more recipients for an image. A computing device 2205 includes an input element 2210 and a display element 2215 (e.g., a touch screen actuatable display element for interfacing and/or inputting). An interface 2220 is provided via a display region of display element 2215. Interface 2220 includes an interface element 2225 for inputting one or more recipients for an image. In one example, a user may utilize input element 2210 (e.g., via directing a pointer display element designed to move over interface 2220 and/or a pop-up screen displayable keyboard) and/or a touch screen component (e.g., to select a segment of interface 2220 and/or to actuate a pop-up screen displayable keyboard for entering one or more recipients) of display element 2215 to designate one or more recipients. Interface 2220 also includes a user actuatable element 2230 for indicating that designation of one or more recipients is complete. An interface for designating one or more recipients for an image may include a “next” actuatable element, such as actuatable element 2230, configured to allow a user to move to a next interface display screen in a set of interface display screens and/or to begin a transmission of an image (e.g., a divided image, an acquired image). In one example, actuation of element 2230 displays the next interface in an order (e.g., an interface for dividing an image). In another example, actuation of element 2230 begins transmission of an image (e.g., an image acquired via device 2205, an image divided via device 2205 in a prior interface display screen, etc.). In on example, actuation of element 2230 may include utilization of input element 2210 and/or a touch screen component of display element 2215.

FIG. 23 illustrates one exemplary implementation of an interface for dividing an image (e.g., via dividing a representation of the image). A computing device 2305 includes an input element 2310 and a display element 2315 (e.g., a touch screen actuatable display element for interfacing and/or inputting). An interface 2320 is provided via a display region of display element 2315. Interface 2320 is configured to provide a user with an ability to position one of more lines 2325 to divide an image into a plurality of portions. Interface 2320 also includes a “next” user actuatable element 2330. In one example, actuation of element 2330 displays the next interface display screen in an order. In another example, actuation of element 2330 begins transmission of image. An interface for dividing an image, such as interface 2320, may also include an additional action element 2335 configured to allow a user to perform one or more additional actions. Examples of an additional action include, but are not limited to, providing one or more additional visual information (e.g., text, graphics, etc. for inclusion with one or more portions of one or more images), selection of an image to be acquired for dividing (e.g., from a folder stored on a memory element of a computing device), actuation of a camera associated with a computing device for acquiring an image, storage of a divided image on a memory element associated with a computing device (e.g., to allow for transmission using a different interface, such as a social networking application), posting a divided image to a social networking service (e.g., Facebook, Instagram, etc.), and any combinations thereof.

Information received via a plurality of interfaces that are provided to a user may be transmitted from a sending computing device in a variety of orders. Such information may be transmitted from a sending computing device at the same time. In one example, an interface for designating one or more recipients is provided, designation of one or more recipients is received via the interface, an interface for dividing an image is provided, an instruction for dividing an image into a plurality of portions is received, and information regarding the one or more recipients and the divided image is transmitted after the instruction for dividing is received (e.g., at about the same time). In another example, an interface for dividing an image is provided, an instruction for dividing the image into a plurality of portions is received, an interface for designating one or more recipients is provided, designation of one or more recipients is received via the interface, and information regarding the one or more recipients and the divided image is transmitted after the instruction for dividing is received (e.g., at about the same time). Information provided via a plurality of interfaces may also be transmitted from a sending computing device at different time. In one example, an interface for designating one or more recipients is provided, designation of one or more recipients is received via the interface, transmission of information regarding the one or more recipients is started at a time prior to the receipt of instructions for dividing an image, an interface for dividing an image is provided, an instruction for dividing the image into a plurality of portions is received, and the divided image is transmitted after the instruction for dividing is received. In another example, an interface for dividing an image is provided, an instruction for dividing the image into a plurality of portions is received, transmission of the divided image is started prior to designation of one or more recipients, an interface for designating one or more recipients is provided, designation of one or more recipients is received via the interface, and information regarding the one or more recipients is transmitted after the instruction after receipt of the designation. Other variations of transmission are also possible. Streaming in one or more streams to one or more recipient computing devices is also contemplated as a mode of transmission.

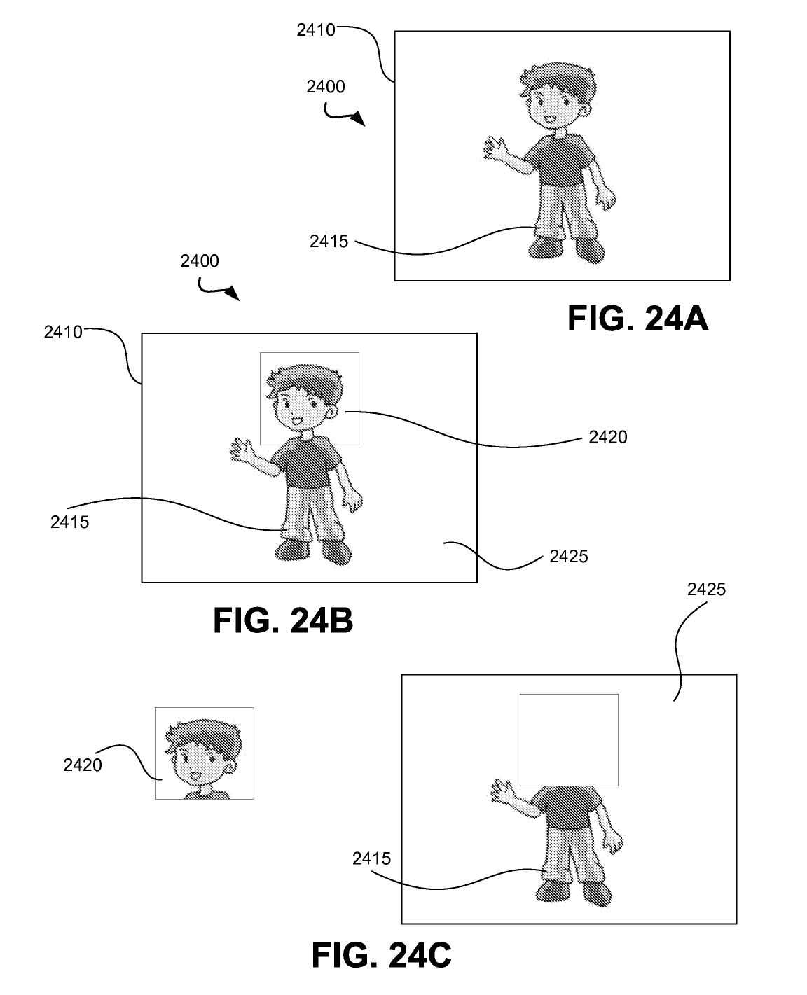

FIGS. 24A to 24C illustrate one exemplary implementation of a way of automatically dividing an image. An image 2410 includes an area bound by a perimeter 2410. Image 2410 includes a subject 2415 having a face. Automatic facial recognition can be utilized to identify a subregion of the area having at least a part of the face of subject 2415. FIG. 24B illustrates an example dividing of image 2410 into a portion 2420 and a portion 2425 using automatic facial recognition. Various forms of automatic facial recognition are known and can be utilized with the current methods and implementations. FIG. 24C illustrates separated display of portion 2420 and portion 2425.

It is to be noted that any one or more of the aspects and embodiments described herein may be conveniently implemented using one or more machines (e.g., one or more computing devices, such as computing device 700 of FIG. 7) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above that lend themselves to employing software and/or software modules may also include appropriate hardware for assisting in the implementation of the machine executable instructions of the software and/or software module.

Such software may be a computer program product that employs a machine-readable hardware storage medium. A machine-readable hardware storage medium may be any medium that is capable of storing and/or encoding a sequence of instructions for execution by a machine (e.g., a computing device) and that causes the machine to perform any one of the methodologies and/or embodiments described herein. Examples of a machine-readable hardware storage medium include, but are not limited to, a solid state memory, a flash memory, a random access memory (e.g., a static RAM “SRAM”, a dynamic RAM “DRAM”, etc.), a magnetic memory (e.g., a hard disk, a tape, a floppy disk, etc.), an optical memory (e.g., a compact disc (CD), a digital video disc (DVD), a Blu-ray disc (BD); a readable, writeable, and/or re-writable disc, etc.), a read only memory (ROM), a programmable read-only memory (PROM), a field programmable read-only memory (FPROM), a one-time programmable non-volatile memory (OTP NVM), an erasable programmable read-only memory (EPROM), an electrically erasable programmable read-only memory (EEPROM), and any combinations thereof. A machine-readable hardware storage medium, as used herein, is intended to include a single medium as well as a collection of physically separate media, such as, for example, a collection of compact discs or one or more hard disc drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Some of the details, concepts, aspects, features, characteristics, examples, and/or alternatives of a component/element discussed above with respect to one implementation, embodiment, and/or methodology may be applicable to a like component in another implementation, embodiment, and/or methodology, even though for the sake of brevity it may not have been repeated above. It is noted that any suitable combinations of components and elements of different implementations, embodiments, and/or methodologies (as well as other variations and modifications) are possible in light of the teachings herein, will be apparent to those of ordinary skill, and should be considered as part of the spirit and scope of the present disclosure. Additionally, functionality described with respect to a single component/element is contemplated to be performed by a plurality of like components/elements (e.g., in a more dispersed fashion locally and/or remotely). Functionality described with respect to multiple components/elements may be performed by fewer like or different components/elements (e.g., in a more integrated fashion).

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed:

1. A method of viewing an electronic image on a user device, the method comprising:
displaying an image display region for the electronic image via a first computing device;
displaying a first portion of the electronic image in a first subregion of the image display region;
displaying a second portion of the electronic image in a second subregion of the image display region, the display of the first portion and the second portion being such that:
when the first portion of the electronic image is displayed in the first subregion, a first substitute portion is displayed in the second subregion in place of the second portion; and
when the second portion of the electronic image is displayed in the second subregion, a second substitute portion is displayed in the first subregion in place of the first portion; and
automatically repeating the displaying of the first portion and the displaying of the second portion.

2. A method according to claim 1, wherein the first portion includes identifying information that in itself identifies a first subject included in the electronic image and the second portion does not include identifying information that in itself identifies the first subject.

3. A method according to claim 1, further comprising:
acquiring the electronic image via a second computing device;
receiving an input from a user of the second computing device, the input including instructions for dividing the electronic image into a plurality of portions; and
providing the electronic image to the first computing device.

4. A method according to claim 3, wherein the acquiring the electronic image includes capturing an image using a camera element of the second computing device.

5. A method according to claim 3, wherein the acquiring the electronic image includes accessing a file of the electronic image stored on a memory element associated with the second computing device.

6. A method according to claim 3, wherein the receiving an input from a user includes:
providing the user with an interface for positioning one or more lines for dividing the electronic image to into the plurality of portions; and
receiving from the user instructions for positioning the one or more lines via the interface.

7. A method according to claim 3, wherein the providing the electronic image includes providing the instructions for dividing the electronic image into the plurality of portions.

8. A method according to claim 1, wherein the first computing device receives the electronic image and instructions related to the division of the electronic image into the first portion and the second portion.

9. A method according to claim 1, further comprising acquiring the electronic image via a second computing device.

10. A method according to claim 9, further comprising automatically dividing the electronic image into the plurality of portions.

11. A method according to claim 10, wherein the automatically dividing the electronic image includes:
using facial recognition to identify at least a portion of a face of a first subject in the electronic image;
automatically dividing the electronic image such that the at least a portion of a face is included in the first portion of the electronic image and not included in the second portion of the electronic image.

12. A method according to claim 10, wherein the automatically dividing the electronic image occurs at the second computing device, the first computing device, and/or an intermediate computing device between the first computing device and the second computing device.

13. A method according to claim 1, further comprising modifying an image parameter of one of the first portion and the second portion prior to said displaying the first portion and said displaying the second portion.

14. A method according to claim 13, wherein the image parameter includes a parameter selected from the group consisting of: a picture quality parameter, an image exposure parameter, an image lighting parameter, an image aperture parameter, an image zoom parameter, an image size parameter, an image color, an image contrast, an image luminance, and any combinations thereof.

15. A method according to claim 13, further comprising receiving from a user of a second computing device an instruction regarding the modifying an image parameter.

16. A method according to claim 1, further comprising acquiring the electronic image via the first computing device.

17. A method according to claim 1, further comprising displaying a third portion of the electronic image in a third subregion of the image display region, the display of the first portion, the second portion, and the third portion being such that:
when the first portion of the electronic image is displayed in the first subregion, the first substitute portion is displayed in the second subregion in place of the second portion and a third substitute portion is displayed in the third subregion in place of the third portion;
when the second portion of the electronic image is displayed in the second subregion, the second substitute portion is displayed in the first subregion in place of the first portion and a fourth substitute portion is displayed in the third subregion in place of the third portion; and
when the third portion of the electronic image is displayed in the third subregion, a fifth substitute portion is displayed in the first subregion in place of the first portion and a sixth substitute portion is displayed in the second subregion in place of the second portion.

18. A method according to claim 17, wherein the first and sixth substitute portions are the same substitute portion, the second and fifth substitute portions are the same substitute portion, the third and fourth substitute portions are the same substitute portion, the first and third substitute portions are the same substitute portion, the second and fourth substitute portions are the same portions, and/or the fifth and sixth substitute portions are the same portions.

19. A machine-readable hardware storage medium comprising machine executable instructions implementing a method of viewing an electronic image on a user device, the instructions comprising:
a set of instructions for displaying an image display region for the electronic image via a first computing device;
a set of instructions for displaying a first portion of the electronic image in a first subregion of the image display region;
a set of instructions for displaying a second portion of the electronic image in a second subregion of the image display region, the display of the first portion and the second portion being such that:
when the first portion of the electronic image is displayed in the first subregion, a first substitute portion is displayed in the second subregion in place of the second portion; and
when the second portion of the electronic image is displayed in the second subregion, a second substitute portion is displayed in the first subregion in place of the first portion; and
a set of instructions for automatically repeating the displaying of the first portion and the displaying of the second portion.

20. A system for viewing an electronic image on a user device, the system comprising:
a means for displaying an image display region for the electronic image via a first computing device;
a means for displaying a first portion of the electronic image in a first subregion of the image display region;
a means for displaying a second portion of the electronic image in a second subregion of the image display region, the display of the first portion and the second portion being such that:
when the first portion of the electronic image is displayed in the first subregion, a first substitute portion is displayed in the second subregion in place of the second portion; and
when the second portion of the electronic image is displayed in the second subregion, a second substitute portion is displayed in the first subregion in place of the first portion; and
a means for automatically repeating the displaying of the first portion and the displaying of the second portion.
